(19) United States
(12) Patent Application Publication
(10) Pub. No.: US 2019/0084087 A1
(43) Pub. Date: Mar. 21, 2019

(54) ENERGY MACHINED POLYCRYSTALLINE DIAMOND COMPACT AND RELATED METHODS

(71) Applicant: US SYNTHETIC CORPORATION, Orem, UT (US)

(72) Inventors: Mark Pehrson CHAPMAN, Provo, UT (US); Nicholas Edward CHRISTENSEN, Spanish Fork, UT (US); Ronald Wilford WARD, Pleasant Grove, UT (US); Brandon Alan JOHNSON, Provo, UT (US); Jason Clark CARDELL, Lehi, UT (US)

(21) Appl. No.: 16/084,469

(22) PCT Filed: Jan. 10, 2018
(86) PCT No.: PCT/US18/13069

§ 371 Date: Sep. 12, 2018

Related U.S. Application Data
(60) Provisional application No. 62/456,785, filed on Feb. 9, 2017.

(51) Int. Cl. B23K 26/352; B24D 99/00; E21B 10/567

(52) U.S. Cl. CPC B23K 26/3576; E21B 10/567; B24D 99/005

(57) ABSTRACT

Embodiments disclosed herein are directed to energy beam ablation machining methods that are used to machine polycrystalline diamond tables (e.g., polycrystalline diamond compacts that each includes polycrystalline diamond tables). Embodiments disclosed herein also are directed to polycrystalline diamond tables machined according to at least one of the energy beam ablation machining methods disclosed herein.

### CROSS-REFERENCE TO RELATED APPLICATIONS

This application claims priority to U.S. Provisional Application No. 62/456,785 filed on 9 Feb. 2017, the disclosure of which is incorporated herein, in its entirety, by this reference.

### BACKGROUND

Wear-resistant, polycrystalline diamond compacts (“PDCs”) are utilized in a variety of mechanical applications. For example, PDCs are used in drilling tools (e.g., cutting elements, gage trimmers, etc.), machining equipment, bearing apparatuses, wire-drawing machinery, and in other mechanical apparatuses.

PDCs have found particular utility as superabrasive cutting elements in rotary drill bits, such as roller-cone drill bits and fixed-cutter drill bits. A PDC cutting element typically includes a superabrasive diamond layer/volume commonly known as a diamond table. The diamond table is formed and bonded to a substrate using a high-pressure/high-temperature (“HPHT”) process that sinters diamond particles under diamond-stable conditions. The PDC cutting element may also be brazed directly into a preformed pocket, socket, or other receptacle formed in a bit body. The substrate may optionally be brazed or otherwise joined to an attachment member, such as a cylindrical backing. A rotary drill bit typically includes a number of PDC cutting elements affixed to the bit body. It is also known that a stud carrying the PDC may be used as a PDC cutting element when mounted to a bit body of a rotary drill bit by press-fitting, brazing, or otherwise securing the stud into a receptacle formed in the bit body.

Conventional PDCs are normally fabricated by placing a cemented carbide substrate into a container with a volume of diamond particles positioned on a surface of the cemented carbide substrate. A number of such containers may be loaded into an HPHT press. The substrate(s) and volume of diamond particles are then processed under HPHT conditions in the presence of a catalyst material that causes the diamond particles to bond to one another to form a matrix of bonded diamond grains defining a polycrystalline diamond (“PCD”) table. The catalyst material is often a metal-solvent catalyst (e.g., cobalt, nickel, iron, or alloys thereof) that is used for promoting intergrowth of the diamond particles.

In a conventional approach, a constituent of the cemented carbide substrate, such as cobalt from a cobalt-cemented tungsten carbide substrate, liquefies and sweeps from a region adjacent to the volume of diamond particles into interstitial regions between the diamond particles during the HPHT sintering process. The cobalt acts as a catalyst to promote intergrowth between the diamond particles, which results in formation of a matrix of bonded diamond grains having diamond-to-diamond bonding there between, with interstitial regions between the bonded diamond grains being occupied by the solvent catalyst.

It is often desirable to machine the PCD table, such for forming a chamfer in the PCD table or for cutting the PDC to provide a desired shape. Such cutting has typically been accomplished by electrical-discharge machining, grinding, lapping, or combinations thereof to remove desired portions of the PCD table and substrate.

Despite the availability of such manufacturing methods, manufacturers and users of PDCs continue to seek improved PDC manufacturing methods.

### SUMMARY

Embodiments disclosed herein are directed to energy beam ablation machining methods (e.g., laser polishing techniques electron beam polishing techniques, electron beam shaping techniques, and/or laser shaping techniques) that may be used to machine PCD. Embodiments disclosed herein also are directed to PCD tables machined (e.g., polished and/or shaped) according to at least one of the energy beam machining methods disclosed herein.

In an embodiment, a method of machining a polycrystalline diamond (“PCD”) table is disclosed. The method includes providing the PCD table. The PCD table includes a plurality of bonded diamond grains defining a plurality of interstitial regions. At least one exterior surface of the PCD table exhibits a first surface roughness. The method also includes directing a laser beam towards at least a portion of the at least one exterior surface effective to cause the at least a portion of at least one exterior surface to exhibit a second surface roughness that is less than the first surface roughness. Directing the laser beam includes directing at least one first laser pulse towards the at least one exterior surface to remove PCD from a first surface area and directing at least one second laser pulse towards the at least one exterior surface. The at least one second laser pulse overlaps about 25% to about 99.95% of the first surface area.

In another embodiment, a PDC is disclosed. The PDC includes a PCD table. The PCD table includes a plurality of bonded diamond grains defining a plurality of interstitial regions. The PCD table also includes at least one exterior surface. At least a portion of the at least one exterior surface exhibiting a surface roughness less than about 3 μm Ra. The at least a portion of the at least one exterior surface exhibiting a rastering pattern including one or more microfeatures.

In another embodiment, a drill bit is disclosed. The drill bit including a bit body. The drill bit also including at least one cutter coupled with the bit body. The at least one cutter including at least one PCD table. The PCD table includes a plurality of bonded diamond grains defining a plurality of interstitial regions. The PCD table also includes at least one exterior surface. At least a portion of the at least one exterior surface exhibits a surface roughness less than about 3 μm Ra. The at least a portion of the at least one exterior surface exhibits a rastering pattern that includes one or more microfeatures.

Other embodiments include applications utilizing the disclosed PDCs in various articles and apparatuses, such as wire-drawing dies, machining equipment, friction stir welding elements, laser mirrors, heat sinks, and other articles and apparatuses.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1A is an isometric view of a PDC including a PCD table attached to a cemented carbide substrate along an interfacial surface thereof, according to an embodiment.

FIG. 1B is an isometric view of a PCD table that may otherwise be similar to the PCD table of FIG. 1A, but which is unattached to any substrate.

FIG. 1C is a cross-sectional view through an embodiment of a PCD table that has been leached to form a leached region adjacent to a working surface and extending inwardly therefrom to an unleached region within which a concentration of catalyst or infiltrant has not been significantly reduced as a result of leaching.

FIGS. 2A-2L are cross-sectional views of different PCD tables that are machined by removing one or more layers/volumes of PCD material therefrom, according to different embodiments.

FIG. 3A is a schematic top view of at least a portion of an exterior surface of a PCD table that include a plurality of substantially parallel first recesses formed therein, according to an embodiment.

FIG. 3B is a schematic cross-sectional view of a portion of the exterior surface of the PCD table of FIG. 3A, according to an embodiment.

FIG. 3C is a schematic top view of at least a portion of the exterior surface of the PCD table shown in FIG. 3A that includes the plurality of substantially parallel first recesses and a plurality of substantially parallel second recesses formed therein, according to an embodiment.

FIGS. 3D-3G are top views of PCD tables that have had a plurality of layers/volumes of PCD material removed from an exterior surface thereof.

FIG. 4A is a graph illustrating an energy/intensity distribution of a laser pulse exhibiting a Gaussian energy distribution, according to an embodiment.

FIG. 4B is a partial cross-sectional side view of a PCD table that has been machined using a plurality of laser pulses exhibiting the Gaussian energy distribution shown in FIG. 4A, according to an embodiment.

FIG. 4C is a graph illustrating an energy/intensity distribution of a laser pulse exhibiting a top-hat energy distribution, according to an embodiment.

FIG. 4D is a partial side view of a PCD table that has been machined using a plurality of laser pulses exhibiting the top-hat energy distribution shown in FIG. 4C, according to an embodiment.

FIG. 5A is a partial side view of an exterior surface of a PCD table, according to an embodiment.

FIG. 5B is a partial side view of a surface of a PCD table, according to an embodiment.

FIGS. 6A-6D are schematic top plan views of at least one exterior surface of a PCD table illustrating different methods of forming overlapping divots, overlapping recesses, etc., according to different embodiments.

FIGS. 7A-7H are top views of a portion of an exterior surface of a PCD table that is subdivided into distinct regions, according to different embodiments.

FIG. 8A is a schematic illustration of a system that is configured to machine at least one exterior surface of a PCD table of a PDC, according to an embodiment.

FIG. 8B is a schematic view of at least a portion of an exterior surface of a PCD table showing a path of laser pulses on and near the exterior surface.

FIGS. 9A-9K illustrate shapes and/or surfaces in a PCD table that may be machined using any of the laser techniques disclosed herein, according to different embodiments.

FIG. 10A is an isometric view of an embodiment of a rotary drill bit for use in subterranean drilling applications that may include at least one of the PDC embodiments disclosed herein.

FIG. 10B is a top plan view of the rotary drill bit shown in FIG. 10A.

FIG. 11 is an isometric cutaway view of an embodiment of a thrust-bearing apparatus, which may include at least one of the disclosed PDC embodiments as bearing elements.

FIG. 12 is an isometric cutaway view of an embodiment of a radial bearing apparatus, which may include at least one of the disclosed PDC embodiments as bearing elements.

### DETAILED DESCRIPTION

### I. Introduction

Embodiments disclosed herein are directed to energy beam ablation machining methods (e.g., laser polishing techniques electron beam polishing techniques, electron beam shaping techniques, and/or laser shaping techniques) that may be used to machine PCD (e.g., a PDC comprising a PCD table). Embodiments disclosed also directed to PCD machined according to at least one of the machining methods disclosed herein. Machining methods disclosed herein may provide improved methods compared to conventional machining method (e.g., lapping, grinding, electrical discharge machining, etc.). For example, grinding or lapping with a diamond wheel is typically relatively slow compared to some machining techniques and expensive, as diamond is typically used to remove diamond material. Additionally, using EDM to machine the PCD is sometimes impractical or even impossible, particularly when the amount of cobalt or other electrically conductive infiltrant or catalyst in the PCD is relatively low (e.g., leached PCD). Additionally, if performed improperly, grinding, lapping, and using EDM to machine a surface of PCD may damage the PCD table. As such, energy beam ablation machining methods disclosed herein may provide an effective alternative to conventional machining techniques.

In an embodiment, at least one exterior surface of a PCD material may be machined by emitting a plurality of energy beams or pulses (e.g., laser beams, laser pulses, electron beams, or electron beam pulses) towards the exterior surface. For example, an energy pulse includes any energy pulse having a duration that is less than about 1 millisecond and an energy beam include any energy beam having a duration that is greater than about 1 millisecond. Each of the energy beams or pulses may exhibit an effective area and intensity sufficient energy to ablate PCD material. Each of the effective areas of the energy beams or pulses may form a corresponding divot in the surface of the PCD material. One or more of the divots may form a recess. For example, a recess may be formed from a plurality of consecutively formed, overlapping divots by rastering (e.g., moving) the energy beams or pulses sequentially across the exterior surface of the PCD material. The divots and/or recesses may be formed by removing a plurality of regions of PCD material. Each of the regions removed may achieve a surface finish of or and/or a shape of the exterior surface.

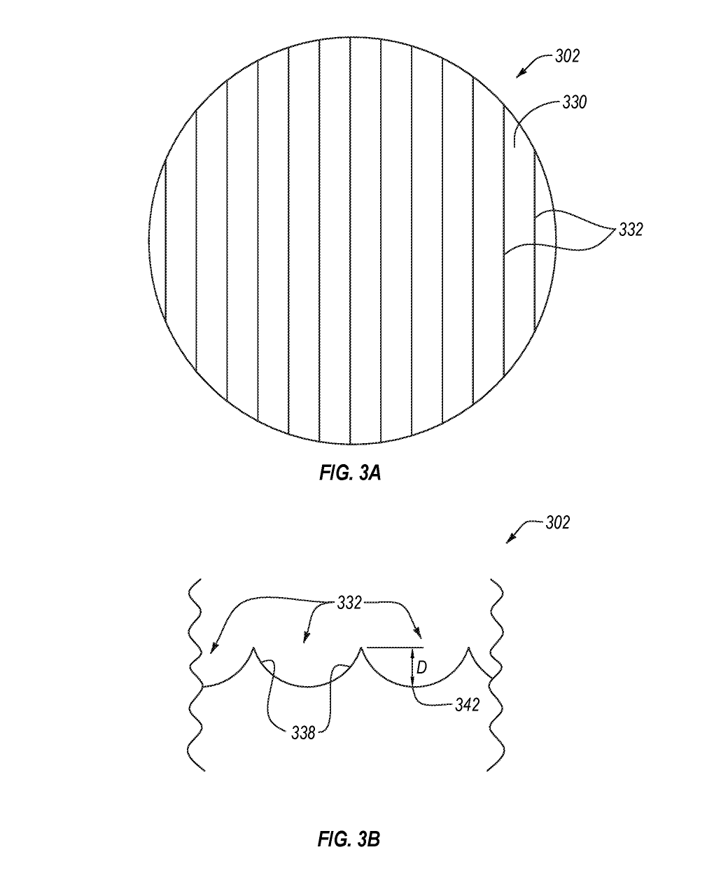

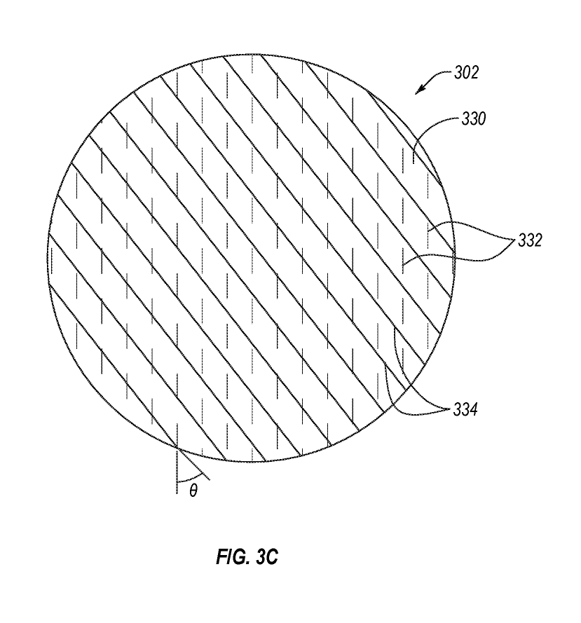

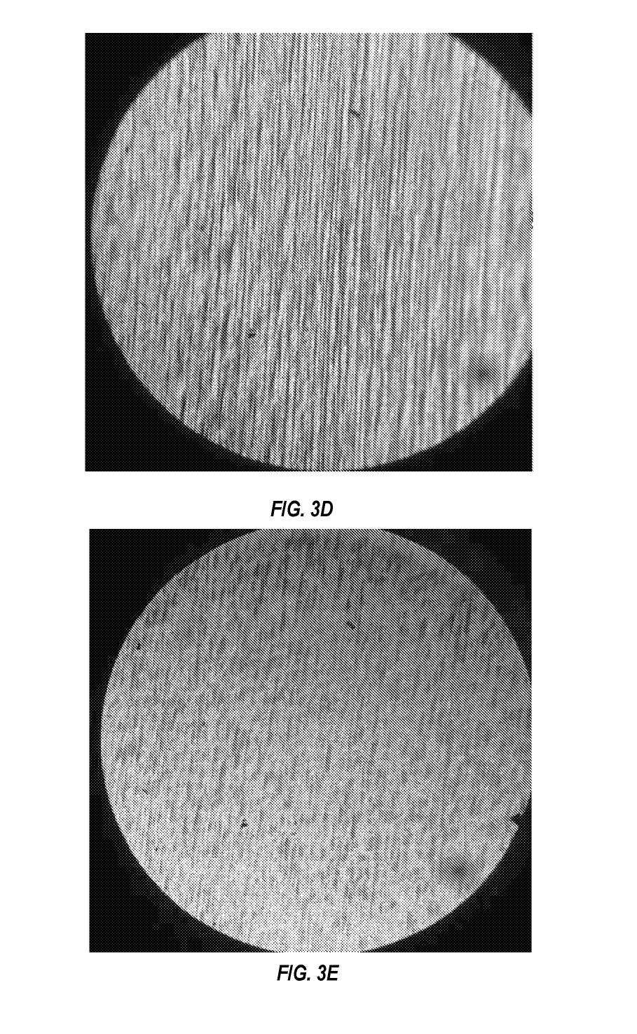

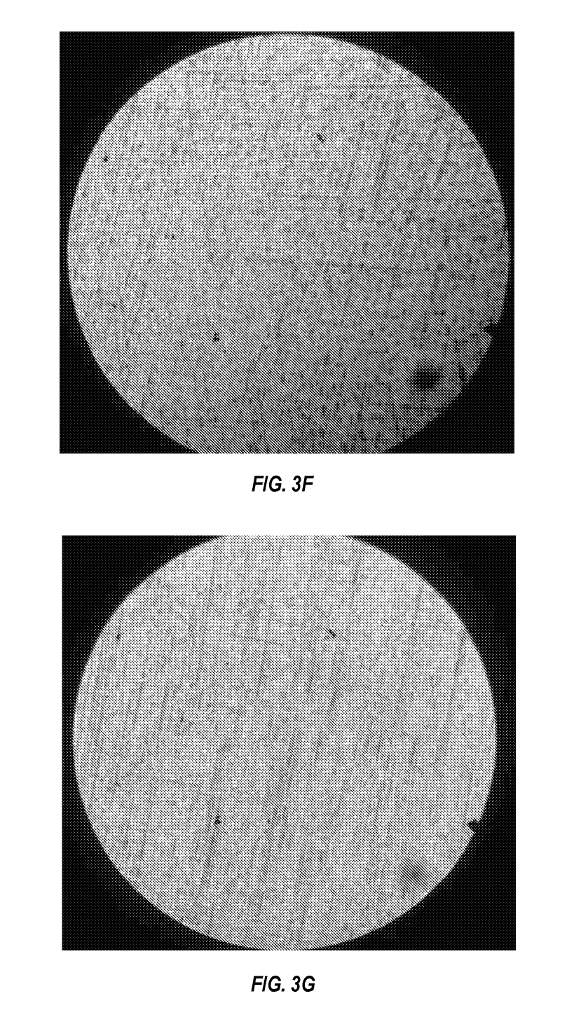

In an embodiment, the energy beam machining methods disclosed herein may improve the surface finish on the PCD table. In another embodiment, the energy beam machining methods may or form a rastering pattern that is observable. The observable rastering pattern may be formed from and exhibit the pattern of at least some of the plurality of recesses that are used to remove PCD material from the PCD table. For example, the observable rastering patterns may be observable with an optical microscope (e.g., a width of the plurality of recesses is greater than about 500 nm or greater than about 1 μm), a scanning electron microscope (e.g., a width of the plurality of recesses is greater than about 1 nm, greater than about 10 nm, or about 1 nm to about 500 nm), or with the unaided human eye (e.g., a width of the plurality of recesses is greater than about 5 μm or greater than about 25 μm). For example, the PCD table may be machined using a plurality of substantially parallel recesses and, as such, the observable rastering pattern may form a plurality of substantially parallel lines. In another example, the PCD table may be machined using a first plurality of recesses followed by a second plurality of recesses that are non-parallel to the first plurality of recesses (see FIG. 3C). In such an example, the observable rastering patterns can exhibit the pattern of the first plurality of recesses and, more predominately, the second plurality of recesses. It is currently believed by the inventors that such observable rastering patterns are not formed using conventional machining processes.

For simplicity, the energy beam machining methods disclosed herein are described as being used to machine PCD materials. However, it is understood that the energy beam machining methods disclosed herein may also be used to machine superhard materials other than polycrystalline diamond. Superhard materials include any material exhibiting a hardness greater than tungsten carbide. For example, a superhard material may include polycrystalline diamond, silicon carbide, diamond-silicon carbide composition, polycrystalline cubic boron nitride, another suitable superhard material, or combinations thereof. As such, the energy beam machining methods disclosed herein may be used to machine superhard elements (e.g., elements that include at least one superhard material).

### II. Polycrystalline Diamond Tables and Compacts

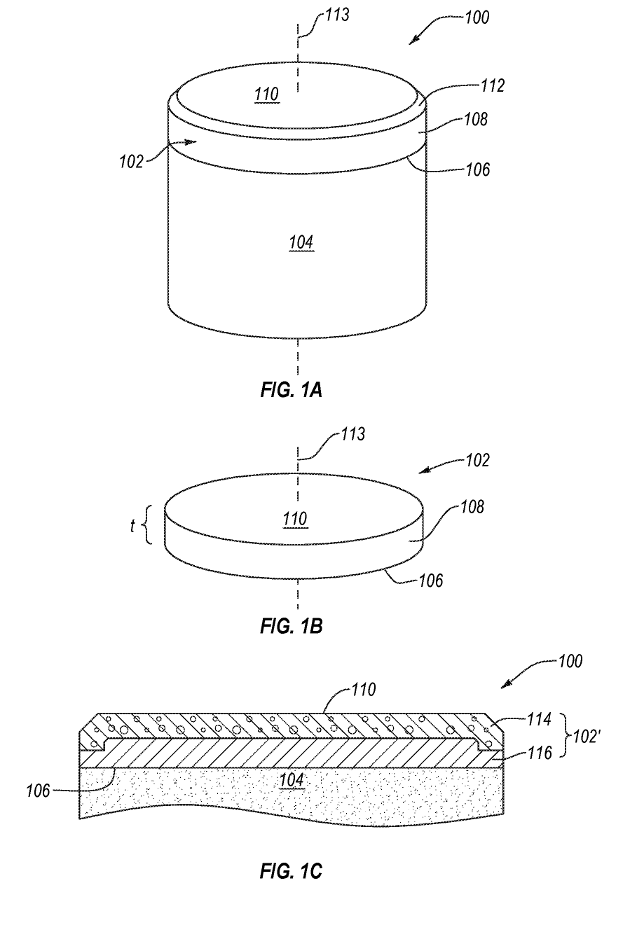

FIG. 1A is an isometric view of a PDC 100 including a PCD table 102 attached to a cemented carbide substrate 104 along an interfacial surface 106 thereof, according to an embodiment. FIG. 1B is an isometric view of a PCD table 102 that may otherwise be similar to the PCD table 102 of FIG. 1A, but which is unattached to any substrate. In either case, the PCD table 102 includes a plurality of directly bonded-together diamond grains exhibiting diamond-to-diamond bonding (e.g., spa bonding) therebetween. The PCD table 102 includes at least one lateral surface 108, an upper exterior working surface 110, and an optional chamfer 112 extending therebetween. It is noted that at least a portion of the at least one lateral surface 108 and/or the chamfer 112 may also function as a working surface that contacts a subterranean formation during drilling operations.

The bonded-together diamond grains of the PCD table 102 may exhibit an average grain size of about 100 μm or less, about 40 μm or less, such as about 30 μm or less, about 25 μm or less, or about 20 μm or less. For example, the average grain size of the diamond grains may be about 10 μm to about 18 μm, about 8 μm to about 15 μm, about 9 μm to about 12 μm, or about 15 μm to about 25 μm. In some embodiments, the average grain size of the diamond grains may be about 10 μm or less, such as about 2 μm to about 5 μm or submicron.

The diamond particle size distribution of the diamond particles used to form the PCD table 102 may exhibit a single mode, or may be a bimodal or greater grain size distribution. In an embodiment, the diamond particles may comprise a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the diamond particles may include a portion exhibiting a relatively larger average particle size (e.g., 50 μm, 40 μm, 30 μm, 20 μm, 15 μm, 12 μm, 10 μm, 8 μm, including ranges between any of the provided relatively larger average particle sizes) and another portion exhibiting at least one relatively smaller average particle size (e.g., 6 μm, 5 μm, 4 μm, 3 μm, 2 μm, 1 μm, 0.5 μm, less than 0.5 μm, 0.1 μm, less than 0.1 μm, including ranges between any of the provides relatively smaller average particle sizes). In an embodiment, the diamond particles may include a portion exhibiting a relatively larger average particle size between about 10 μm and about 40 μm and another portion exhibiting a relatively smaller average particle size between about 1 μm and 4 μm. In some embodiments, the diamond particles may comprise three or more different average particle sizes (e.g., one relatively larger average particle size and two or more relatively smaller average particle sizes), without limitation. It is noted that the as-sintered diamond grain size may be substantially the same as the diamond particle size used to form the PCD table 102 (e.g., as disclosed herein) or may differ from the average particle size of the diamond particles prior to sintering due to a variety of different reasons, such as grain growth, diamond particles fracturing, carbon provided from another carbon source (e.g., dissolved carbon in the metal-solvent catalyst), or combinations of the foregoing.

The PCD table 102 may exhibit a thickness “t” of at least about 0.040 inch, such as about 0.045 inch to about 1 inch, about 0.045 inch to about 0.500 inch, about 0.050 inch to about 0.200 inch, about 0.065 inch to about 0.100 inch, or about 0.070 inch to about 0.100 inch (e.g., about 0.09 inch). The thickness may vary depending on the application of the PCD table 102. For example, the PCD table 102 may be thicker if it is used in a drill bit compared to a PCD table that is used to machine metals.

The PCD table 102 may or may not include an interstitial catalyst or infiltrant disposed in at least a portion of the interstitial regions between the bonded diamond grains of the PCD table 102. The catalyst or infiltrant may include, but is not limited to, iron, nickel, cobalt, and alloys of the foregoing metals. For example, a catalyst or infiltrant may be provided from the substrate 104 (e.g., cobalt from a cobalt-cemented carbide substrate). In embodiments in which a region of the PCD table 102 is substantially free of catalyst or infiltrant (e.g., less than about 4% by weight, or no more than about 2% by weight), the catalyst or infiltrant may have been removed by leaching, such as by immersing the PCD table 102 in an acid, such as aqua regia, nitric acid, hydrofluoric acid, mixtures thereof, or other suitable acid. For example, leaching the PCD table 102 may form a leached region that extends inwardly from the working surface 110, the lateral surface 108, and the chamfer 112 to a selected leached depth. The selected leached depth may be about 100 μm to about 1000 μm, about 100 μm to about 300 μm, about 300 μm to about 425 μm, about 350 μm to about 400 μm, about 350 μm to about 375 μm, about 375 μm to about 400 μm, about 500 μm to about 650 μm, or about 650 μm to about 800 μm.

FIG. 1C is a cross-sectional view through an embodiment of a PCD table 102′ that has been leached to form a leached region 114 adjacent to working surface 110 and extending inwardly therefrom to an unleached region 116 within which the concentration of catalyst or infiltrant has not been significantly reduced as a result of leaching. It will be understood that use of a laser for removal of material of the PCD table (or underlying substrate 104) may be carried out on leached or un-leached PCD diamond tables. The ability to energy beam machine (e.g., polish and/or shape) a leached diamond table, which may include no or a very low concentration of electrically conductive catalyst or infiltrant material is particularly advantageous. For example, EDM machining (e.g., polishing and/or shaping) of leached PCD table structures may prove difficult and may sometimes be a practical impossibility because of insufficient electrical conductivity within the PCD table to be machined. Energy beam machining offers an alternative that does not require a minimum threshold level of electrical conductivity within the part in order to allow machining of the part.

U.S. Pat. No. 7,866,418, the disclosure of which is incorporated herein, in its entirety, by this reference, discloses PCD tables and associated PCD compacts formed under conditions in which enhanced diamond-to-diamond bonding occurs. Such enhanced diamond-to-diamond bonding is believed to occur at least partially as a result of the sintering pressure (e.g., at least about 7.5 GPa) employed during the HPHT process. The PCD tables and compacts disclosed therein, as well as methods of fabrication are suitable for energy beam machining or shaping according to the methods disclosed herein.

Referring back to FIG. 1A, the substrate 104 may include a plurality of tungsten carbide and/or other carbide grains (e.g., tantalum carbide, vanadium carbide, niobium carbide, chromium carbide, and/or titanium carbide) cemented together with a metallic cementing constituent, such as cobalt, iron, nickel, or alloys thereof. For example, in an embodiment, the cemented carbide substrate 104 comprises a cobalt-cemented tungsten carbide substrate. In some embodiments, the substrate 104 may include two or more different carbides (e.g., tungsten carbide and chromium carbide).

The PCD table 102 may be formed separately from or integral with the substrate 104 in an HPHT process. When formed separately, the PCD table 102 may be subsequently attached to the substrate 104 in another HPHT process. The temperature of either such HPHT process may typically be at least about 1000° C. (e.g., about 1200° C. to about 1600° C.) and the pressure of either such HPHT process may typically be at least about 4.0 GPa (e.g., about 5.0 GPa to about 12.0 GPa, about 7.0 GPa to about 9.0 GPa, about 6.0 GPa to about 8.0 GPa, 8 GPa to about 10 GPa, about 9.0 GPa to about 12.0 GPa, or at least about 7.5 GPa).

At least one exterior surface of the PDCs 100 and PCD tables 102 formed in the HPHT process (e.g., the lateral surface 108, the working surface 110, and/or the chamfer 112) may exhibit a relatively rough surface finish. For example, at least one exterior surface of the PDCs 100 and PCD tables 102 may exhibit a surface finish that is greater than about 3 μm (all the surface finishes disclosed herein are in Rₐ). A surface finish greater than about 3 μm may be undesirable, (e.g., may increase the coefficient of friction of the PCD table 102 (and/or may increase the temperature of the PCD table 102 during operation). As such, optionally, at least one exterior surface of the PCD table 102 may be polished to improve the surface finish thereof, for example, while the PCD table 102 is shaped. However, as previously discussed, grinding, lapping, EDM, and other conventional machining techniques may be slow and/or expensive. Additionally, grinding, lapping, EDM, and other conventional machining techniques may be unable to obtain certain geometrics and/or fine surface finishes disclosed below. In an embodiment, at least one exterior surface of the PCD table 102 may be energy beam machined (e.g., laser polished or laser machined) to exhibit a surface finish of about 1.5 μm or less. For example, at least one of the lateral surface 108, the working surface 110, or the chamfer 112 may be energy beam polished to exhibit a surface finish of about 1.25 μm or less, about 1 μm or less, about 0.8 μm or less, about 0.65 μm or less, about 0.5 μm or less, about 0.4 μm or less, about 0.3 μm or less, about 0.25 μm or less, about 0.2 μm or less, about 0.15 μm or less, about 0.13 μm or less, about 0.1 μm or less, about 0.05 μm or less, or about 0.025 μm or less. In another embodiment, at least one of the lateral surface 108, the working surface 110, or the chamfer 112 may be energy beam polished to exhibit a surface finish of about 1.5 μm to about 0.025 μm, about 0.65 μm to about 1.5 μm, about 0.5 μm to about 0.75 μm, about 0.4 μm to about 0.65 μm, about 0.10 μm to about 0.5 μm, about 0.05 μm to about 0.25 μm, or about 0.1 μm to about 0.25 μm. In an embodiment, at least one of the lateral surface 108, the working surface 110, or the chamfer 112 may be energy beam polished to exhibit a mirror surface finish (e.g., about 0.05 μm or less). The surface finish may be measured, for example, by a profilometer (e.g., by Rₐ). In an embodiment, laser machining disclosed herein may be used to form features in at least one exterior surface of the PCD table that exhibits a tolerance of about ±3.0 μm or less, such as about ±2.0 μm or less, about ±1.0 μm or less, about ±500 nm or less, or about ±250 nm or less.

In an embodiment, the at least one exterior surface of the PDC 100 and the PCD table 102 may be at least partially polished before the at least one exterior surface is polished using the energy beams or energy pulses disclosed herein. For example, the at least one exterior surface of the PDC 100 and PCD table 102 may exhibit a first surface finish immediately after the HPHT process. The at least one exterior surface may then be polished to exhibit a second surface finish that is finer than the first surface finish using a conventional polishing technique. The second surface finish can be greater than 3 μm (e.g., any of the surface finished disclosed herein that are greater than 3 μm) or less than about 3 μm (e.g., any of the surface finishes disclosed herein that are less than 3 μm). The at least one exterior surface may then be further polished to exhibit a third surface finish that is finer than the second surface finish using the energy beams or energy pulses disclosed herein. The third surface finish is less than about 3 μm (e.g., any of the surface finishes disclosed herein that are less than 3 μm).

In an embodiment, the PDC 100 and/or the PCD table 102 formed in the HPHT process may be further processed to exhibit a selected shape. For example, the PCD table 102 may be shaped to reduce the thickness thereof, make a nonplanar exterior surface thereof substantially planar, or to make a substantially planar surface thereof nonplanar (e.g., concave or convex). In another embodiment, the PDC 100 and/or PCD table 102 may be shaped to form one or more recess (e.g., concave portions) therein. Conventional, grinding, lapping, EDM, or other conventional shaping techniques may prove difficult and/or expensive to shape the PDC 100 and/or PCD 102 in certain geometrics and/or surface finishes.

### III. Energy Beam Machining Methods

The energy beam machining methods disclosed herein may remove material from (e.g., polish and/or shape) at least one exterior surface of the PDC 100 and/or PCD table 102. Similarly, the energy beam machining methods disclosed herein may enable shaping the PDC 100 and/or the PCD table 102. For example, using at least one laser machining technique disclosed herein may enable machining the PDC 100 and/or the PCD table 102 without substantially damaging the PDC 100 and/or the PCD table 102. In another example, using at least one laser machining technique disclosed herein may create at least one exterior surface of the PDC 100 and/or the PCD table 102 exhibiting any of the relatively fine surface finishes disclosed herein. In an embodiment, the PDC 100 and/or PCD table 102 may be machined using merely one of the energy beam machining methods disclosed herein, two or more of the energy beam machining methods disclosed herein, or any combination of steps of the energy beam machining methods disclosed herein.

### A. Removal of a Pluarlity of Layers/Volumes of PCD Material

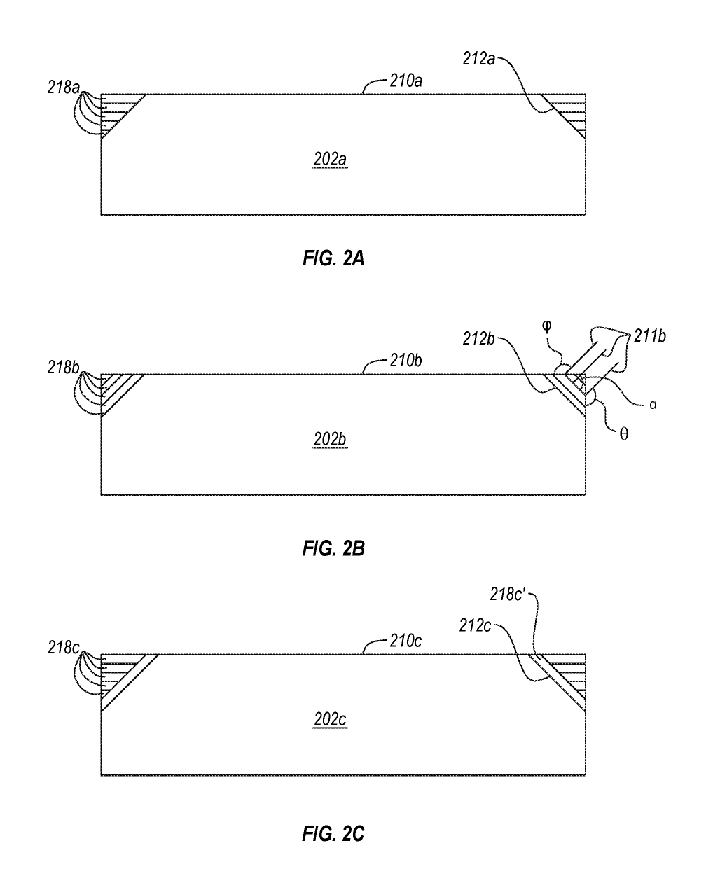

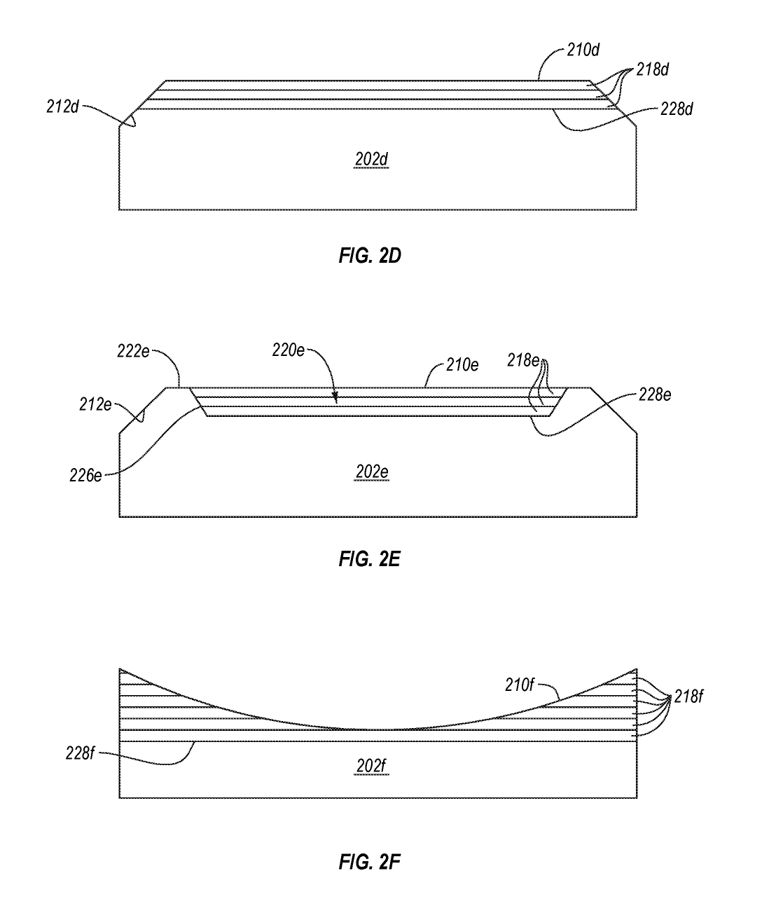

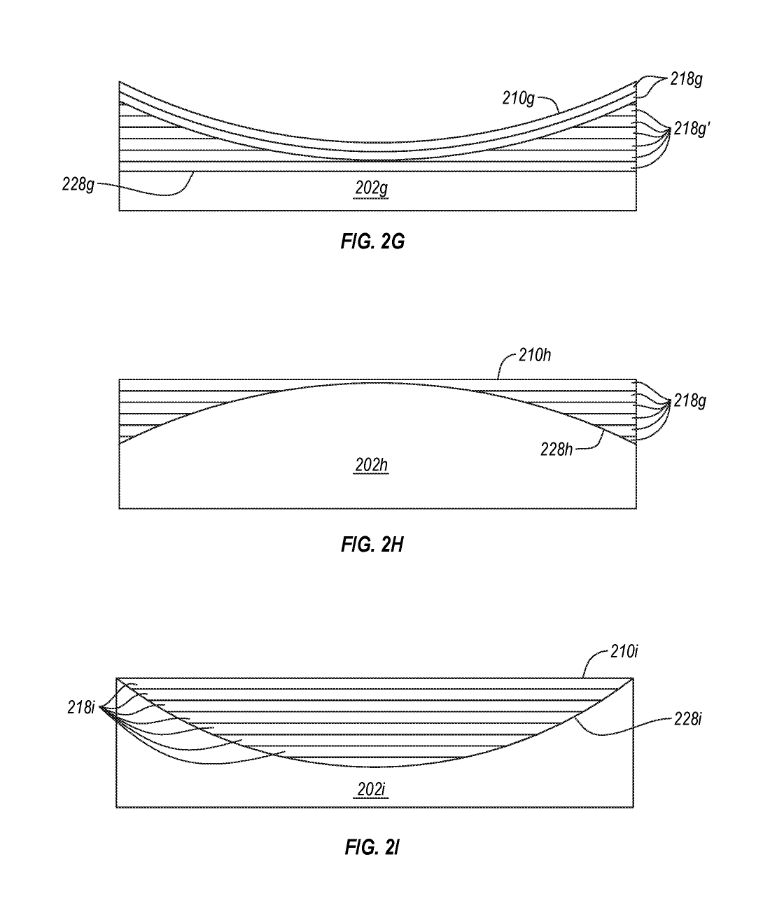

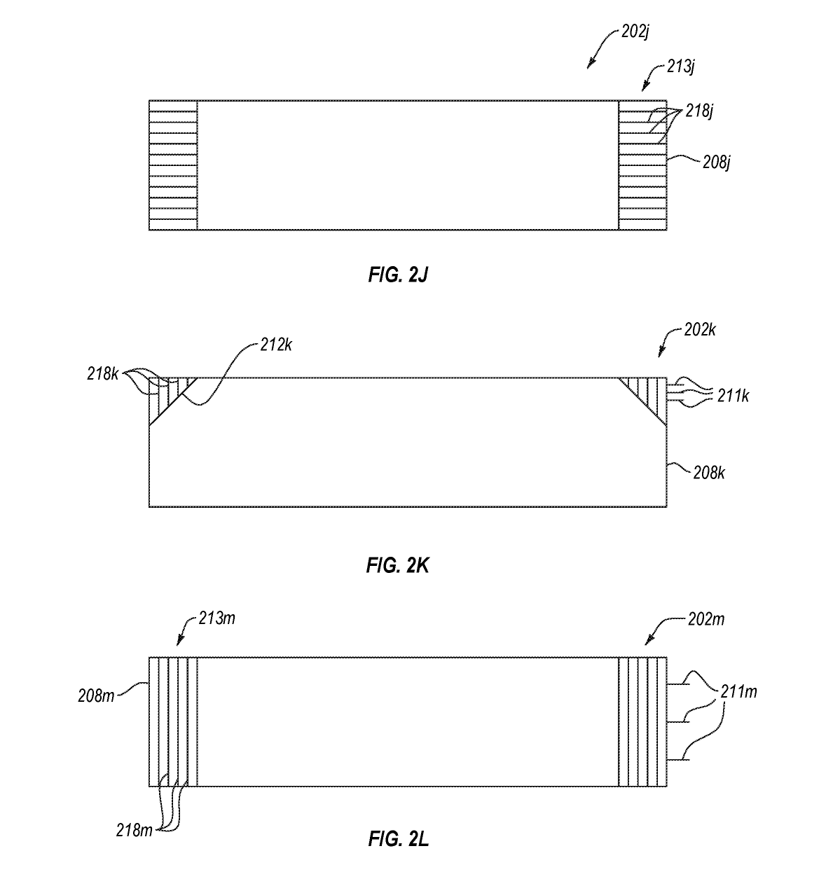

In an embodiment, at least one exterior surface of the PCD table 102 may be machined by removing one or more layers/volumes of PCD material from the PCD table 102. FIGS. 2A-2L are cross-sectional views of different PCD tables that are machined by removing one or more layers/volumes of PCD material therefrom, according to different embodiments. The PCD tables illustrated in FIGS. 2A-2L and the methods of removing PCD material therefrom may be used in any of the embodiments disclosed herein.

Each layer/volume of PCD material that is removed from the PCD table may be removed using at least one energy pulse (e.g., at least one laser pulse or a plurality of laser pulses). For example, each layer/volume of PCD material removed may comprise PCD material removed by forming a single divot, a plurality of divots (e.g., each divot generally corresponds with one of a plurality of protrusions), a single recess, a plurality of recesses, a plurality of overlapping recesses, or combinations thereof.

In an embodiment, each layer/volume of PCD material removed from the PCD table may exhibit a thickness that is less than about 50 μm. For example, the thickness of each layer/volume of PCD material removed from the PCD table may be about 25 μm to about 50 μm, about 10 μm to about 30 μm, about 5 μm to about 15 μm, about 1 μm to about 10 μm, about 500 nm to about 5 μm, about 250 nm to about 1 μm, or less than about 500 nm. The relatively small thickness of each layer/volume removed may improve the surface finish of the exterior surface of the PCD table.

Referring to FIG. 2A, a plurality of layers/volumes 218a are removed from a PCD table 202a to form a chamfer 212a. Each layer/volume 218a may be substantially parallel to the upper surface 210a. Each of the plurality of layers/volumes 218a may be formed by directing a plurality of energy pulses towards the working surface 210a of the PCD table 202a. In an embodiment, each of the plurality of energy pulses may be substantially perpendicular to the upper surface 210a. Directing the plurality of energy pulses substantially perpendicular to the working surface 210a may maximize the amount of PCD material removed from the PCD table 202a with each energy pulse. In an embodiment, each of a plurality of laser pulses impact the PCD table 202a at substantially the same angle such that each laser pulse removes substantially the same amount of PCD material from the PCD table 202a. Removing substantially the same amount of PCD material with each laser pulse may reduce (e.g., eliminate) variations in the thickness of each layer/volume 218a which may improve surface finish of the PCD table 202a.

In an embodiment, the chamfer 212a (e.g., the surface being exposed) may exhibit an observable rastering pattern that is formed by removing at least one of the plurality of layers/volumes 218a (e.g., a pattern formed in response to removal of material by laser ablation, the rastering pattern comprising the divots and/or recesses so removed). The rastering pattern may include one or more microfeatures (e.g., a pattern in which the widths of at some of the divots and/or recesses are less than 999 μm, such as less than 500 μm, less than 100 μm, less than 50 μm, less than 25 μm, less than 10 μm, less than 5 μm, less than 1 μm, less than 500 nm, less than 250 nm, or less than 100 nm). For example, as the layers/volumes 218a removed from the PCD table 202a are not perpendicular or parallel to the chamfer 212a, the chamfer 212a may exhibit a stepped surface that is observable. In an embodiment, the stepped surface of the chamfer 212a may require further polishing (e.g., laser polishing) to improve the surface finish thereof. However, the chamfer 212a may still exhibit the observable rastering pattern after the chamfer 212a is further polished. In an embodiment, the energy beam or energy pulse machining method used to remove each of the layers/volumes 218a may be configured such that the chamfer 212a exhibits a satisfactory surface finish (e.g., such that the chamfer 212a does not require further polishing).

Referring to FIG. 2B, the plurality of layers/volumes 218b may be removed from the PCD table 202b to form the chamfer 212b. Each layer/volume 218b may be substantially parallel to the chamfer 212b being formed. Each of the plurality of layers/volumes 218b may be formed by directing a plurality of energy pulses (e.g., laser pulses) towards a surface that ultimately forms the chamfer 212b. For example, each of the plurality of energy pulses may be emitted to be substantially perpendicular to the chamfer 212b and oblique relative to the upper surface 210b and the lateral surface 208b.

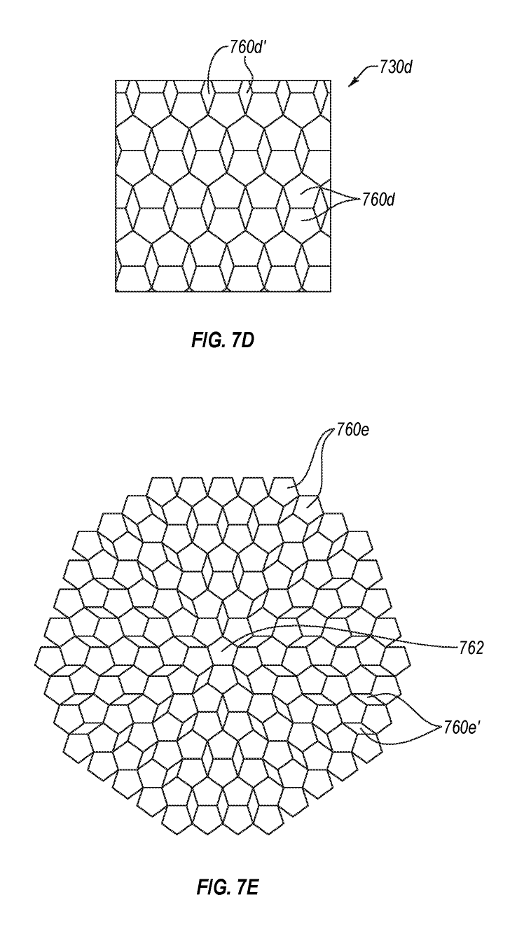

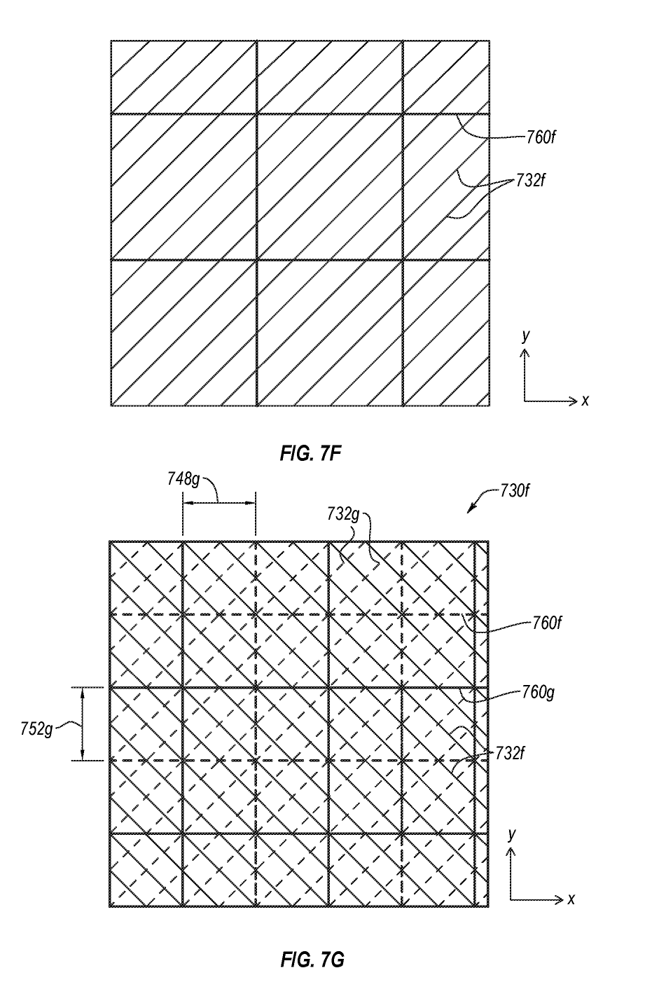

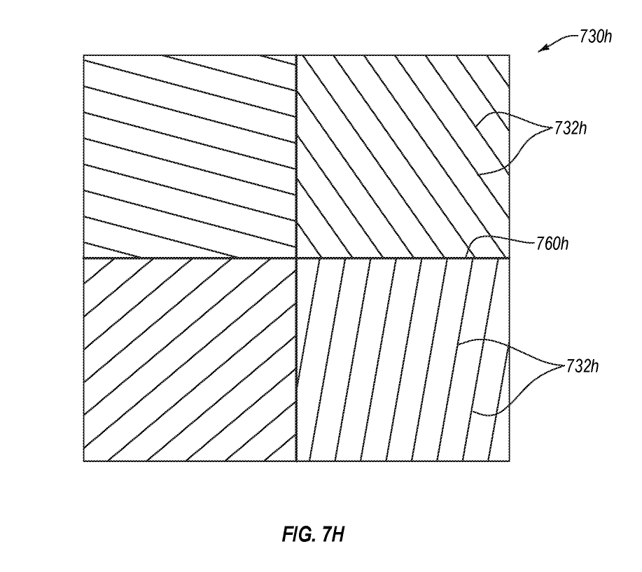

Forming each of the layers/volumes 218b substantially parallel to the chamfer 212b (e.g., the surface being exposed) may form a relatively better surface finish than the chamfer 212a of FIG. 2A. However, the thickness of each layer/volume 218b removed from the PCD table 202b may vary, especially near the edges thereof, because the angle of the energy beams or pulses 211b relative to the surface being exposed to the energy beams or pulses varies. For example, at least two of an angle ϕ between the energy beams or pulses 211b and working surface 210b, an angle θ between the energy beams or pulses 211b and the lateral surface 208b, and an angle α between the energy beams or pulses 211b and an exposed surface of the PCD table 202b spaced from the working surface 210b and the lateral surface 208b may be different. The variation in the angles ϕ, θ, α may result in an observable rastering pattern including one or more microfeatures and/or an nonplanar (e.g., convexly curved) chamfer 212b. However, the laser machining methods disclosed herein may improve the chamfer 212b (e.g., make the chamfer 212b more planar). For example, the overlap between divots and/or recesses formed from the plurality of energy beams or pulses 211b can be configured to compensate for the variation in angles ϕ, θ, α. In another embodiment, the delays can be configured to compensate for the variation in angles ϕ, θ, α. In another embodiment, the laser pulse duration may be varied to compensate for the variation in angles ϕ, θ, α. In another embodiment, distinct regions (e.g., the regions illustrated in FIGS. 7A-7H) may be configured to compensate for the variation in angles ϕ, θ, α. For example, each region may be selected such that at least one of the angles at which the energy beams or pulses 211b relative to the surface of the region remains substantially constant.

Referring to FIG. 2C, the plurality of layers/volumes 218c and at least one plurality of layers/volumes 218c′ are removed from the PCD table 202c to form the chamfer 212c. The at least one first layer/volume 218c may be substantially parallel to the upper surface 210c and the at least one layer/volume 218c′ may be substantially parallel to the chamfer 212c. For example, the plurality of layers/volumes 218c may be used to mitigate the effects of the variation in the angle, as discussed above. Similarly, the at least one layer/volume 218c′ may be used to reduce the stepped surface formed using the layers/volumes 218c (as described in relation to FIG. 2A).

Referring to FIG. 2D, the plurality of layers/volumes 218d may be chosen to reduce the thickness of the PCD table 202d by removing the layers/volumes 218d from an initial upper surface 210d to a final upper surface 228d. The layers/volumes 218d may be removed from the PCD table 202d before, substantially simultaneously with, or after the chamfer 212d is formed in the PCD table 202d. The chamfer 212d may be formed according to any suitable method disclosed herein.

Referring to FIG. 2E, the PCD table 202e initially includes at least one lateral surface 208e, an initial upper surface 210e, and an optional chamfer 212e. A plurality of layers/volumes 218e may be removed from at least a portion of the initial upper surface 210e to form at least one recess 220e. Additionally, the PCD table 202e may include an uppermost exterior surface 222e labeled 222e on FIG. 2E (e.g., spaced furthest from an interfacial surface 206 of the PCD table 202e) of the PCD table 202e. For example, the uppermost exterior surface 222e may be substantially planar, rounded, or pointed.

The recess 220 formed by removing the plurality of layers/volumes 218 may be defined by at least one surface. For example, the recess 220 may be defined by at least one inner transition surface 226e of the PCD table 202e and at least one lowermost exterior surface 228e that is closer to interfacial surface 206 than the uppermost exterior surface 222e. In some embodiments, the inner transition surface 226e may be at least one of tapered, conical, accurate, vertical, stepped, convexly curved, cylindrical concavely curved, horizontal, or substantially planar or combinations of the foregoing geometrics. In some embodiments, the lowermost exterior surface 228e may be at least one of stepped, tapered, convexly curved, concavely curved, substantially planar, substantially parallel or nonparallel to the interfacial surface 206, substantially parallel or nonparallel to the initial upper surface 210e, or substantially parallel or nonparallel to the uppermost exterior surface 222e. In an embodiment, the at least one of the layers/volumes 218e may exhibit a lateral dimension (measured substantially perpendicular to a central axis 113 of the PDC 100 of FIG. 1A or the PCD table 102 of FIG. 1B) that is less than a layer/volume 218e removed prior thereto, thereby forming a tapered, stepped, or curved surface. In an embodiment, the inner transition surface 226e is omitted such that the recess 220 is defined only by the lowermost exterior surface 228e.

Referring to FIG. 2F, a plurality of layers/volumes 218f may be removed to substantially planarize and/or polish a curved (e.g., convexly or concavely curved) initial upper surface 210f of the PCD table 202f. For example, the curved initial upper surface 210f of the PCD table 202f may be formed during the HPHT process. Each of the layers/volumes 218f may be substantially planar (e.g., substantially parallel to the final upper surface 228f) and a lateral dimension thereof may increase with each subsequent layer/volume 218f.

Referring to FIG. 2G, a at least one first layer/volume 218g and at least one second layer/volume 218g′ may be removed to planarize an upper surface 210g of the PCD table 202g. For example, the first layer/volume 218g may be substantially parallel to the initial upper surface 210g. Then, the second layers/volumes 218g′ may form the final upper surface 228g using the same method illustrated in FIG. 2F.

Referring to FIG. 2H, a plurality of layers/volumes 218h may be configured to form a concavely-curved upper surface 228h of the PCD table 202h. For example, the PCD table 202h may initially exhibit a substantially planar upper surface 210h. However, it is noted that the PCD table 202h may also initially exhibit a nonplanar upper surface. The plurality of layers/volumes 218h may then remove the PCD material from the PCD table 202h to form and/or polish the concavely-curved upper surface 228h. In an embodiment, each of the plurality of layers/volumes 218h are substantially parallel to the upper surface 210h. In an embodiment, each of the plurality of layers/volumes 218h are substantially congruent to the concavely curved upper surface 228h. In an embodiment, at least one of the layers/volumes 218h may be substantially parallel to the upper surface 210h and at least one of the layers/volumes 218h may be substantially congruent to the concavely curved upper surface 228h.

Referring to FIG. 2I, a plurality of layers/volumes 218i may be removed to form a convexly-curved upper surface 228i of the PCD table 202i. For example, the PCD table 202i may initially exhibit a substantially planar or nonplanar upper surface 210i. The plurality of layers/volumes 218i may be removed from the PCD table 202i to form and/or polish the convexly-curved upper surface 228i. In an embodiment, at least one of (e.g., all of) the layers/volumes 218i may be substantially parallel to the upper surface 210i and/or at least one of (e.g., all of) the layers/volumes 218i may be substantially congruent to the convexly curved upper surface 228i.

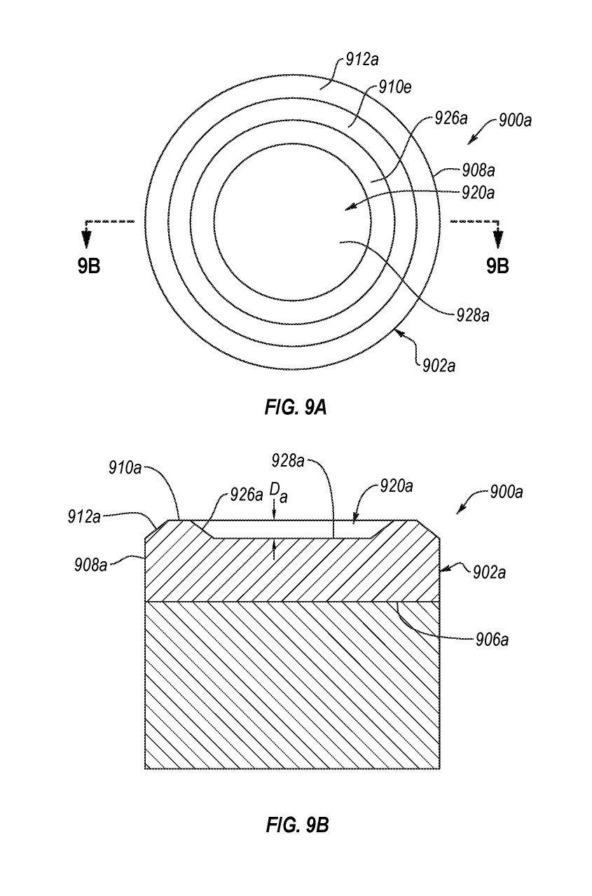

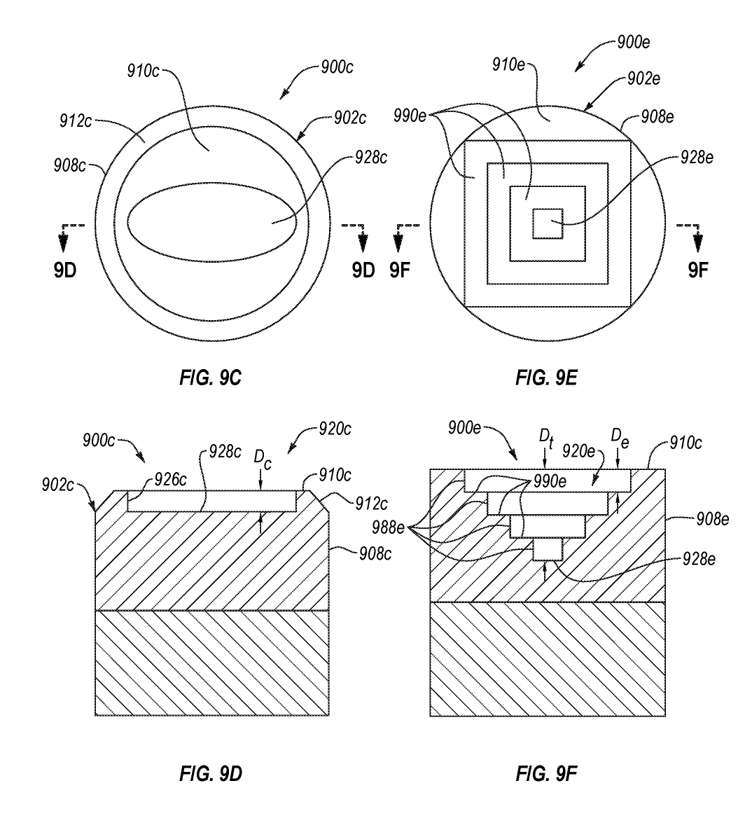

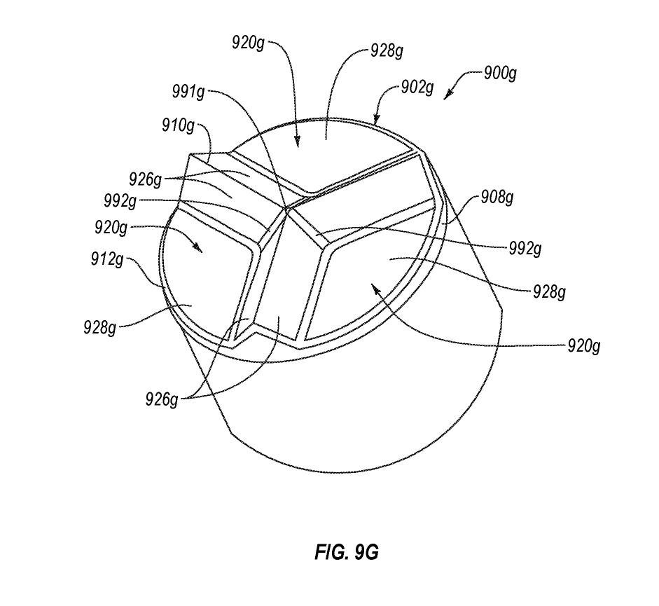

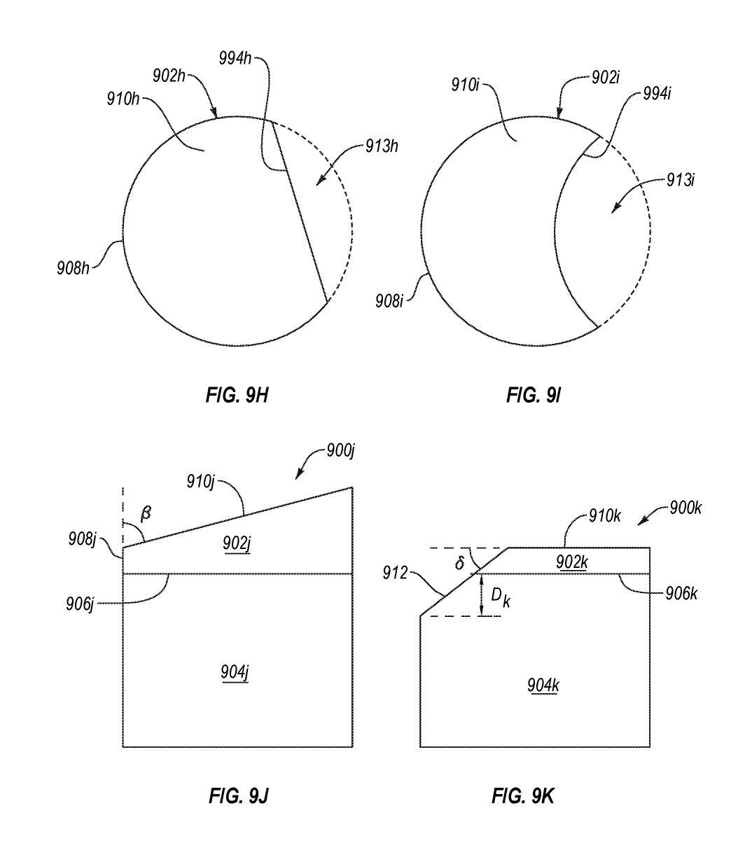

Referring to FIG. 2J, a plurality of layers/volumes 218j may be removed from a lateral portion 213j of the PCD table 202j. For example, the layers/volumes 218j can be configured to reduce a lateral dimension (e.g., the lateral dimension is measured perpendicularly to the central axis 113 of FIGS. 1A and 1B) of the PCD table 202j. In another example, the plurality of layers/volumes 218j may be configured to change the lateral cross-sectional shape of the PCD table 202j. For example the plurality of layers/volumes 218j may be configured to change the cross-sectional shape of the PCD table 202j from a circular cross-sectional shape (e.g., the PCD table 202j is cylindrical) to a generally rectangular cross-sectional shape, a generally elliptical cross-sectional shape, a generally triangular cross-sectional shape, a generally truncated pie cross-section shape, or another suitable cross-sectional shape. In another example, the plurality of layers/volumes 218j may be configured to change the cross-sectional shape of the PCD table 202j to form a spline (e.g., as shown in FIGS. 9H-9I). In another example, the layers/volumes 212j can be configured to remove irregularities on the lateral surface 208j of the PCD table 202j.

In an embodiment, the energy beams or energy pulses may be configured to irradiate the at least one lateral surface of the PCD table. For example, referring to FIG. 2K, the energy beams or energy pulses 211k may irradiate the at least one lateral surface 208k of the PCD table 202k to remove a plurality of layers/volumes 218k thereby forming a chamfer 212k. In another example, referring to FIG. 2L, the energy beams or energy pulses 211m may irradiate the at least one lateral surface 208m of the PCD table 202m to remove a plurality of layers/volumes 218m of the PCD material thereby removing a lateral portion 213m of the PCD table 202m. In such an example, the layers/volumes 218m may be configured to reduce a lateral dimension of, change the cross-sectional shape of, or remove irregularities from the PCD table 202m.

It is noted that the laser machining methods shown in FIGS. 2A-2L, may be combined in any suitable manner or in any suitable order. For example, a PCD table may include a chamfer machined according to the method shown in FIG. 2A and the upper surface of the PCD table may be machined according to the method shown in FIG. 2D.

It is noted that the PCD tables illustrated in FIGS. 2A-2L are freestanding (e.g., not attached to a substrate). In an embodiment, the freestanding PCD tables 202a-202m may be attached to substrates, respectively, after each PCD table is machined. However, in other embodiments, each PCD table 202a-202m may be attached to a substrate prior to machining such PCD table. It is also noted that the same methods of removing PCD material shown in FIGS. 2A-2L may be used to remove material from the substrate. For example, the method illustrated in FIG. 2J or 2L may be used to remove material from a lateral portion of the substrate. In another example, the method illustrated in FIGS. 2-2C and 2K may be used to form a chamfer between the lateral surface of the substrate and a bottommost surface of the substrate.

Referring to FIGS. 2A-2L, any of the PCD tables 202a-202m may be leached prior to or after removing the one or more layers/volumes of PCD material from such PCD table. For example, the leached regions of any PCD table 202a-202m may extend to a relatively uniform depth from the surfaces that are exposed to the leaching agent. As such, if the one or more layers/volumes of PCD material are removed after the leaching process, the one or more layers/volumes of PCD material may remove at least a portion of the leached region. This may result in the thickness of the leached region of the PCD table varying. However, in one embodiment, if the one or more layers/volumes of PCD material are removed prior to the leaching process, the leached region may extend a relatively uniform distance from the exposed surfaces of the PCD table. In other words, in one embodiment, the leached profile of the leached region may substantially correspond to the shape of the exterior surface of the PCD table, created, at least in part, by using the energy beam machining techniques.

### B. Recesses Extending at Non-Parallel Angles

As previously discussed, each of the layers/volumes removed to form a selected shape of the PCD table may be formed from a plurality of recesses. For example, a first layer/volume of PCD material may be removed from at least a portion of PCD table (e.g., from an entirety of a surface or a single distinct region (FIGS. 7A-7H) of the PCD table) by forming a plurality of substantially parallel first recesses and a second layer/volume of PCD material may be removed from at least a portion of PCD table (e.g., from an entirety of a surface or a single distinct region (FIGS. 7A-7H) of the PCD table) after the first layer/volume by forming a plurality of second recesses.

FIG. 3A is a schematic top view of at least a portion of an exterior surface 330 of a PCD table 302 that include a plurality of substantially parallel first recesses formed therein, according to an embodiment. Except as otherwise described herein, the PCD table 302 and its materials, components, elements, or methods of machining may be similar to or the same as the PCD tables 102, 202a-202m (FIGS. 1-2L) and their respective materials, components, elements, or methods of machining. The PCD table 302 or its materials, components, elements, or methods of machining may be used in any of the PCD tables and/or methods of machining disclosed herein.

Referring to FIG. 3A, the PCD table 302 may include a first layer/volume of PCD material removed therefrom. The first layer/volume of PCD material may be removed by forming a plurality of substantially parallel first recesses 332 with an energy beam. For example, each of the first recesses 332 may be formed from a plurality of first laser pulses. In an embodiment, the first recesses 332 may follow a plurality of substantially straight lines. However, one or more of the first recesses may extend in a generally curved manner, generally angular manner, generally sinusoidal manner, generally wobbly manner (e.g., a continuous line with a plurality of loops therein), or any other suitable manner.

FIG. 3B is a schematic cross-sectional view of a portion of the exterior surface 330 of the PCD table 302, according to an embodiment. FIG. 3B illustrates that each of the first recesses 332 form a channel that is defined by a bottommost portion 342 and two side wall 338. The two side walls define a ridge that separates each of the channels. Each of the first recesses 332 exhibit an average depth D that is measured from the top of the side walls 338 to the bottommost portion 342.

One problem with removing the first and second layers/volumes is that, if the second recesses 334 (FIG. 3C) are substantially parallel to the first recesses 332, the second recesses 334 may preferentially remove PCD material adjacent to the bottommost portion 342 relative to the ridge defined by the two side walls 338. For example, the second recesses 334 may remove a relatively small amount of PCD material that is adjacent to the two side walls 338 while removing a relatively large amount of PCD material that is adjacent to the bottommost portion 342. This preferential removal of PCD material adjacent to the bottommost portion 342 relative to the two side walls 333 may increase the depth D of the channel or limit/prevent the formation of channels exhibiting relatively shallow depths D.

To remedy this problem, the second recesses 334 may be non-parallel to the first recesses. FIG. 3C is schematic top view of the at least a portion of an exterior surface 330 of the PCD table 302 that include the plurality of substantially parallel first recesses 332 (shown with phantom lines) and a plurality of substantially parallel second recesses 334 formed therein, according to an embodiment. The PCD table 302 may include a second layer/volume of PCD material removed therefrom. The second layer/volume of PCD material may be removed by forming a plurality of substantially parallel second recesses 334 (shown using solid lines) with an energy beams or energy pulses (e.g. a laser beams or laser pulses). The second recesses 334 are illustrated as following a plurality of substantially straight lines, however, one or more of the second recesses 334 may extend in any suitable path (as described above relative to the plurality of first recesses 332).

The second recesses 334 may be oriented at an angle θ relative to the first recesses 332. Angle θ may be greater than 0° or less than 180°. For example, the angle θ may be greater than 0° to about 20°, about 15° to about 45°, about 30° to about 60°, about 50° to about 80°, about 60° to about 90°, about 70° to about 100°, about 90° to about 120°, about 110° to about 140°, about 130° to about 160°, or about 150° to less than 180°. The inventors currently believe that increasing the angle θ by a slight amount greater than 0° (e.g., 3°) or slightly less than 180° (e.g., 177°) may improve the surface finish of the PCD table 302 by reducing or preventing the second recesses 334 reinforcement of the channels and ridges formed by the first recesses 332. However, the inventors currently believe that the surface finish of the PCD table 302 may be relatively smooth if angle θ is significantly greater than 0° and significantly less than 180°. For example, the angle θ may be about 20° to about 160° about 30° to about 150°, about 45° to about 135°, or about 60° to about 120°.

In an embodiment, remnants, features and/or shadows (e.g., slight suggestions or traces) of channels and recesses formed while removing a first layer/volume of PCD material from the PCD table 302 may still remain after several layers/volumes of PCD material are removed from the PCD table 302. As such, the inventors currently believe that the surface finish of the PCD table 302 may be improved by selecting the angle θ to be an angle with a magnitude equal to about any prime number that is less than 180. Such angles θ may reduce or prevent recesses formed in subsequent layers/volumes from reinforcing the remnants, features, shadows, channels, and/or ridges formed by previous recesses. In an embodiment, the angle θ may be selected to be α or β. α may include any angle that is a prime number, such as a prime number selected from about 1°, about 7°, about 11°, about 13°, about 17°, about 19°, about 23°, about 29°, about 31°, about 37°, about 41°, or about 43° and β may include any angle selected from (90°−α), (90°+α), or (180°−α).

In an embodiment, the angle between recesses used to remove a first layer/volume of PCD material and recesses that are used to remove a second layer/volume of PCD material immediately after the first layer/volume of PCD material may be selected from two or more different angles that are repeated in a selected pattern. For example two or more different angles and the pattern of repeating the two or more angles may be selected such that the orientation of each different plurality of recesses formed are not parallel to the orientation of another plurality of recesses until at least 180 different angles have been utilized. For example, the angles between the pluralities of recesses may be selected from angles γ and δ and the angles γ and δ may be selected to repeat in an alternating pattern (e.g., γδγδγδγδ). In such an example, γ may be 90° and δ may be α, −α, (45°+α), or (45−α). For example, an angle between a plurality of first recesses and a plurality of second recesses can be γ, an angle between the plurality of second recesses and a plurality of third recesses can be δ, an angle between the plurality of third recesses and a plurality of fourth recesses can be γ, and so forth. However, it is understood that other suitable angles γ and δ may be selected.

In an embodiment, the angle between subsequent pluralities of recesses PCD material may be selected by varying the direction (e.g., angle) that a laser beam moves relative to the PCD table 302 (e.g., the PCD table 302 is substantially stationary) after each plurality of recesses is formed. In an embodiment, the angle between subsequent pluralities of recesses formed into PCD material may be selected by rotating the PCD table relative to the laser device after the first plurality of recesses is formed and before a second plurality of recesses is formed. In an embodiment, the angle θ may be selected by varying the direction (e.g., angle) that the PCD table 302 moves relative to the laser device (e.g., the laser device is substantially stationary) after each plurality of recesses is formed.

In an embodiment, the rastering patterns of at least some of the recesses formed by removing the most recent layer/volume of PCD material from the PCD table 302 may be observable and may include one or more microfeatures. In an embodiment, the remnants and/or shadows of recesses formed by removing a layer/volume of PCD material prior to the most recent layer/volume of PCD material may also form observable rastering patterns including one or more microfeatures.

FIGS. 3D-3G are top view of PCD tables that have had a plurality of layers/volumes of PCD material removed from an exterior surface thereof using laser ablation along a pattern of parallel lines (e.g., see FIGS. 3A and 3C) to remove each layer. In the embodiment illustrated in FIG. 3D, the angle θ (see FIGS. 3A and 3C). between each of the plurality of recesses formed into the PCD material was selected to be 0 (e.g., identical rastering patterns were followed to laser ablate the recesses). As shown in FIG. 3D, selecting the angle θ to be 0 results in a relatively rough surface finish. In the embodiment illustrated in FIG. 3E, the angle θ between each of the plurality of recesses formed into the PCD material was selected to be 3°. As shown in FIG. 3E, even the relatively small angle θ improves the surface finish of the PCD table. Additionally, FIG. 3E illustrates that the exterior surface of the PCD table exhibits an observable rastering pattern including one or more microfeatures. In the embodiment illustrated in FIG. 3F, the angle θ between the orientation of each of the pluralities of recesses formed into the PCD material was selected to be 79°. As shown in FIG. 3F, selecting the angle θ to be a prime number resulted in an improved surface finish. Additionally, FIG. 3F also illustrates that the exterior surface of the PCD table exhibits an observable rastering pattern formed from the recesses in the most recent layer/volume of PCD table and remnants, features and/or shadows of previously-formed recesses. In the embodiment illustrated in FIG. 3G, the angle θ between each of the pluralities of recesses formed into the PCD material was selected to be an alternating pattern of γ and δ, where γ is 90° and δ is 41°. As shown in FIG. 3G, selecting a series of orientation angles where at least one of such orientation angles is a prime number resulted in an improved surface finish. Additionally, FIG. 3G also illustrates that the exterior surface of the PCD table still exhibits an observable rastering pattern formed from the recesses in the most recent layer/volume of PCD table and remnants, features, and/or shadows of previously-formed.

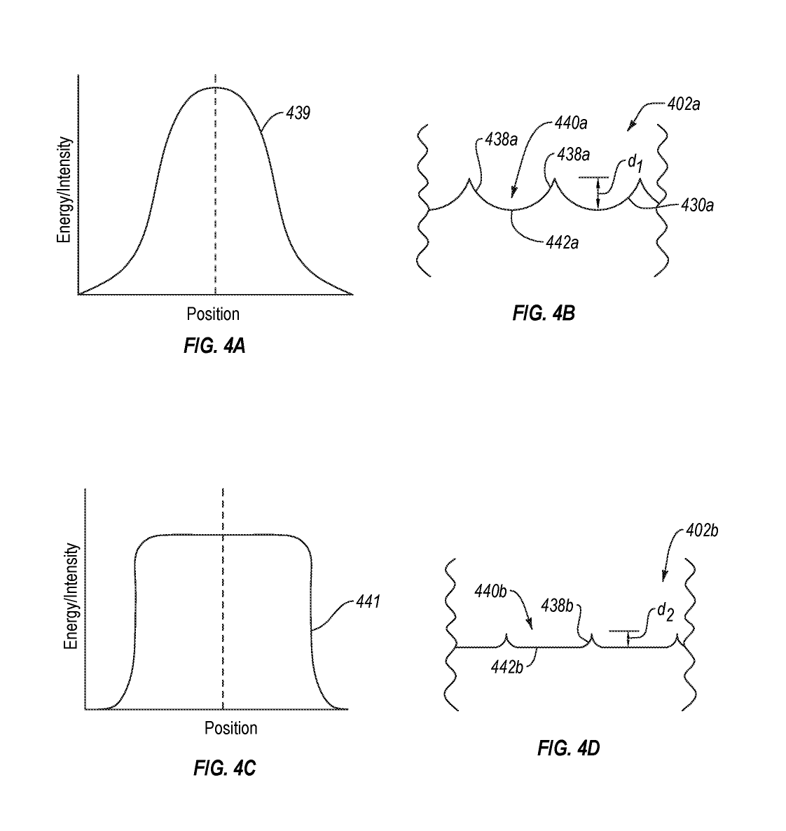

C. Energy Pulses Exhibiting a Generally Top Hat Energy Distribution FIG. 4A is a graph illustrating an energy/intensity distribution 439 as a function of beam width of a laser pulse exhibiting a generally Gaussian energy distribution (e.g., the energy distribution exhibits a general bell-curve shape), according to an embodiment. FIG. 4B is a partial cross-sectional side view of a PCD table 402a that has been machined using a plurality of laser pulses exhibiting the Gaussian energy distribution 439 of FIG. 4A, according to an embodiment. As shown, an exterior surface 430a of the PCD table 402a includes a plurality of divots 440a formed therein. Each of the divots 440a includes a bottommost portion 442a and a side wall 438a. Further, a ridge 437a separates adjacent divots 440a. FIG. 4B illustrates that divots 440a formed from laser pulses exhibiting the Gaussian energy distribution 439 are characterized by: bottommost portions 442a that exhibit a relatively rounded shape; two side walls 438a defining ridges that are relatively large; and a relatively large depth d₁. For example, the shape and relatively large depth d₁ of the divots 440a are caused by the Gaussian energy distribution 439 having a generally circular beam shape cross-section and exhibiting a greater energy distribution at a center thereof.

The surface finish of any of the PCD tables disclosed herein may be improved by flattening the bottommost portions of the divots and decreasing the size of the side walls. FIG. 4C is a graph illustrating an energy/intensity distribution 441 as a function of beam width of a laser pulse exhibiting a generally top-hat energy distribution, according to an embodiment. FIG. 4D is a partial side view of a PCD table 402b that has been machined using a plurality of laser pulses exhibiting the top-hat energy distribution 441 shown in FIG. 4C, according to an embodiment. Except as otherwise described herein, the PCD table 402b and its materials, components, elements, or methods of machining the PCD table 402b may be similar to or the same as the PCD tables 102, 202a-i, 302 (FIGS. 1-3B) and their respective materials, components, elements, or methods of machining the PCD tables 102, 202a-i, 302. The PCD table 402b or its materials, components, elements, or methods of machining the PCD table 402b may be used in any of the PCD tables and/or methods of machining disclosed herein.

Referring to FIG. 4C, the top-hat energy distribution 441 shown differs from a Gaussian energy distribution 439 of FIG. 4A in that the top and sides of the top-hat energy distribution 441 are relatively flatter and relatively more vertical, respectively, than the top and sides of a Gaussian energy distribution. As shown in FIG. 4D, the shape of the top-hat energy distribution 441 results a plurality of divots 440b that exhibit a relatively flatter bottommost portion 442b and relatively smaller ridges 437b compared to the ridges 437a illustrated in FIG. 4B. This geometry is formed due to the laser pulse removing less PCD material at a location proximate a center of the laser pulse and more PCD material at a location spaced from the center of the laser pulse than a laser pulse exhibiting a Gaussian energy distribution 439. As such, the divots 440b may exhibit a smaller average depth d₂ than the average depth d′ of the divots 440a of FIG. 4B, which may improve the surface finish of the exterior surface 430b of the PCD table 402b.

### D. Energy Beam Pulse Duration

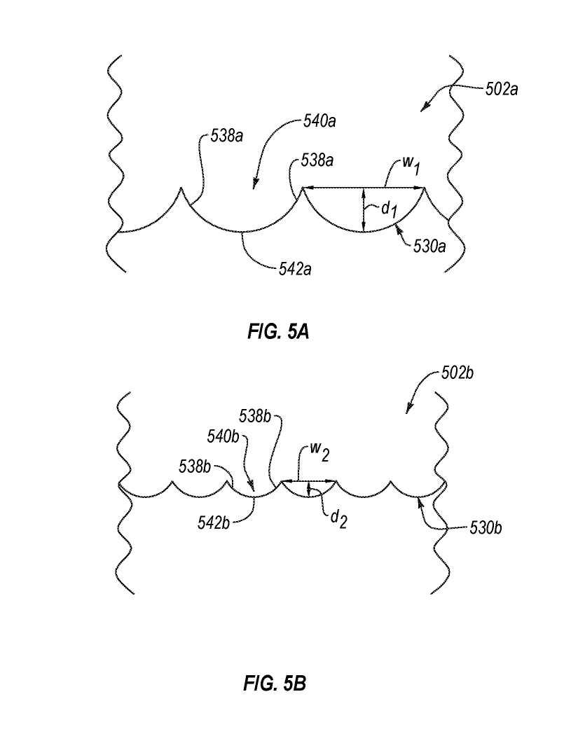

The surface finish of a PCD table may be improved by decreasing the energy beam pulse duration of the energy beam or pulses used to remove the layers/volumes of PCD material. FIG. 5A is a partial side view of an exterior surface 530a of a PCD table 502a, according to an embodiment. FIG. 5B is a partial side view of a surface 530b of a PCD table 502b, according to an embodiment. Except as otherwise described herein, the PCD tables 502a, 502b and their materials, components, elements, or methods of machining the PCD tables 502a, 502b may be similar to or the same as the PCD tables 102, 202a-i, 302, 402a-b (FIGS. 1-4C) and their respective materials, components, elements, or methods of machining the PCD tables 102, 202a-i, 302, 402a-b. The PCD tables 502a, 502b or their materials, components, elements, or methods of machining the PCD table 502a, 502b may be used in any of the PCD tables and/or methods of machining disclosed herein.

Referring to FIG. 5A, the exterior surface 530a includes a plurality of divots 540a formed therein. In an embodiment, the divots 540a may be formed using laser pulses exhibiting a laser pulse duration that is relatively long (e.g., greater than about 500 microseconds (“μs”)). Each divot 540a includes a bottommost portion 542a and a side wall 538a. The relatively long pulse duration causes each of the divots 540a to be relatively large. For example, the divots 540a exhibit a relatively large average width W₁ and a relatively large average depth d₁. The relatively large average depth d₁ may limit the surface finish of the PCD table 502a.

Referring to FIG. 5B, the exterior surface 530b includes a plurality of divots 540b formed therein. The divots 540b are formed using laser pulses exhibiting a laser pulse duration that is relatively short (e.g., less than the pulse durations used to form the divots 540a of FIG. 5A, such as less than 500 μs). Each divot 540b includes a bottommost portion 542b and a side wall 538b. The relatively short pulse duration of the laser pulses may cause each of the divots 540b to be relatively small. For example, the divots 540b may exhibit a relatively small average width W2 and a relatively small depth d₂. The relatively short average depth d₂ may allow the exterior surface 430b of the PCD table 502b to exhibit a finer surface finish than the surface 530a of FIG. 5A.

As shown in FIGS. 5A and 5B, decreasing the laser pulse duration of the laser pulses may improve the surface finish of the PCD table that is being machined. Referring to FIG. 5B, the laser pulse duration of the laser pulses used to machine the PCD table 502b may be in the microsecond (“μs”) range (e.g., about 500 μs to about 1 μs), the nanosecond (“ns”) range (e.g., about 1000 ns to about 1 ns), the picosecond (“ps”) range (e.g., about 1000 ps to about 1 ps), or in the femtosecond (“fs”) range (e.g., about 1000 fs to about 1 fs). For example, the laser pulse duration of the laser pulses used to machine the PCD table 502b may be about 500 μs to about 250 μs, about 300 μs to about 150 μs, about 200 μs to about 100 μs, about 150 μs to about 50 μs, about 75 μs to about 1 μs, about 10 μs to about 450 ns, about 500 ns to about 250 ns, about 300 ns to about 150 ns, about 200 ns to about 100 ns, about 150 ns to about 50 ns, about 75 ns to about 1 ns, about 10 ns to about 450 ps, about 500 ps to about 250 ps, about 300 ps to about 150 ps, about 200 ps to about 100 ps, about 150 ps to about 50 ps, about 75 ps to about 1 ps, about 10 ps to about 450 fs, about 800 fs to about 500 fs, about 600 fs to about 400 fs, about 500 fs to about 300 fs, about 400 fs to about 200 fs, about 300 fs to about 100 fs, or about 150 fs to about 1 fs.

Referring back to FIG. 5A, the relatively long laser pulse duration of the laser pulses can cause thermal damage to the PCD table 502a. For example, laser pulses exhibiting a laser pulse duration in the μs range or greater may cause thermal energy that does not ablate the PCD material to instead be transferred into the PCD material that is proximate to the divot 540a. This thermal energy may create damage in the PCD table 502a due to the relatively large temperature gradients in a relatively small area, the differences in the thermal expansion coefficients of the PCD material and the interstitial constituents of the PCD table 502a (e.g., metal solvent catalysts), or due to other deleterious effects. Large thermal stresses in the PCD table 502 can potentially cause microcracks to form in the PCD table 502a.

Referring back to FIG. 5B, decreasing the laser pulse duration of the laser pulses decreases the amount of thermal energy transferred to the PCD table 502b, which may decrease the amount of damage the PCD table 502b. As such, the relatively short laser pulse duration of the laser pulses used to machine the PCD table 502b may maintain the toughness and/or strength of the PCD table 502b. For example, a laser pulse exhibiting a laser pulse duration in the ns range significantly decreases the amount of damage in the PCD table 502b compared to a laser pulse exhibiting a laser pulse duration in the μs range.

In an embodiment, decreasing the laser pulse duration of the laser pulses into the ps range may change the mechanism that removes the PCD material. Under certain conditions, laser pulses may remove PCD material via a photoablation process. A photoablation process removes PCT material from the PCD table 502b without substantially damaging the remaining PCD material. For example, it is currently believed by the inventors that photoabalation becomes the predominate mechanism of material removal when the laser pulse duration is near the middle of the ps range (e.g., less than about 700 ps, less than about 500 ps, less than about 250 ps) and that photoablation becomes the sole mechanism of material removal when the laser pulse duration is near the lower end of the ps range (e.g., less than about 100 ps, less than about 50 ps, less than about 10 ps). The inventors currently believe that the photoablation process is the sole PCD material mechanism when the laser pulse duration is in the fs range. As such, it is currently believed by the inventors that laser machining with laser pulses having a duration that is less than about 700 ps, less than about 500 ps, less than about 250 ps, less than about 100 ps, less than about 50 ps, or less than about 10 ps may result in substantially no thermal damage to the PCD table 502b.

As shown in FIGS. 5A and 5B, laser pulses exhibiting relatively long laser pulse durations remove more PCD material per laser pulse than laser pulses exhibiting relatively short laser pulse durations. As such, removing PCD material using only the relatively short laser pulse durations may be time consuming Therefore, in an embodiment, the laser pulse duration may vary as the PCD tables are machined. For example, the laser pulse duration of the laser pulses may be relatively long (e.g., in the μs or ns range, greater than 500 μs) when the initial layers/volumes of PCD material are removed. After the initial layers/volumes of the PCD material are removed, the laser pulse duration of the laser pulses may be decreased into the ps range and/or into the fs range. For example, one or more first layers/volumes or rastering patterns may be removed using laser pulses exhibiting first pulse laser duration and, subsequently, one or more second layers/volumes or rastering patterns may be removed using laser pulses exhibiting a second pulse laser duration that is less than the first laser pulse duration. Subsequently, one or more third layers/volumes or rastering patterns may be removed using laser pulses exhibiting a third laser pulse duration that is less than the second laser pulse duration, and so forth. In an embodiment, the one or more final layers/volumes of PCD material may be removed using laser pulses exhibiting a laser pulse duration that is selected to photoablate the PCD material. In such an embodiment, the PCD table may be substantially damage free.

The frequency of selected laser pulses may be selected based on the laser pulse duration of such laser pulses. For example, the frequency may be selected to allow at least some of the thermal energy transferred to the PCD table to be dissipated before another laser pulse causes more thermal energy. For example, the frequency may be selected to be about 20 kHz to about 2 MHz, such as about 20 kHz to about 100 kHz, about 50 kHz to about 200 kHz, about 150 kHz to about 300 kHz, about 250 kHz to about 500 kHz, about 450 kHz to about 750 kHz, about 700 kHz to about 1 MHz, about 900 kHz to about 1.5 MHz, about 1.25 MHz to about 1.75 MHz, or about 1.5 MHz to about 2 MHz.

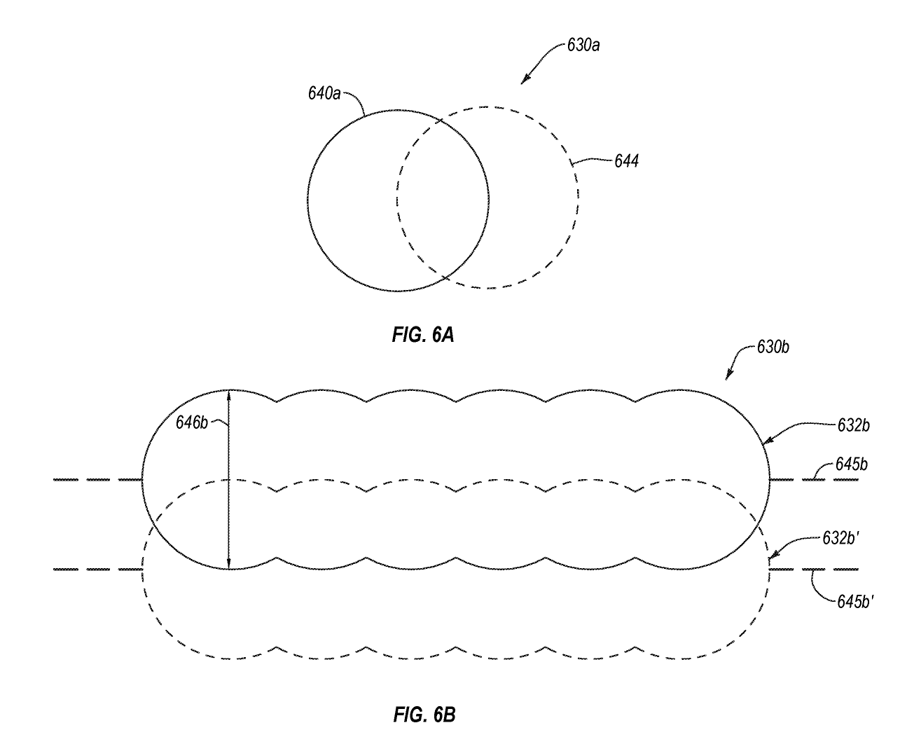

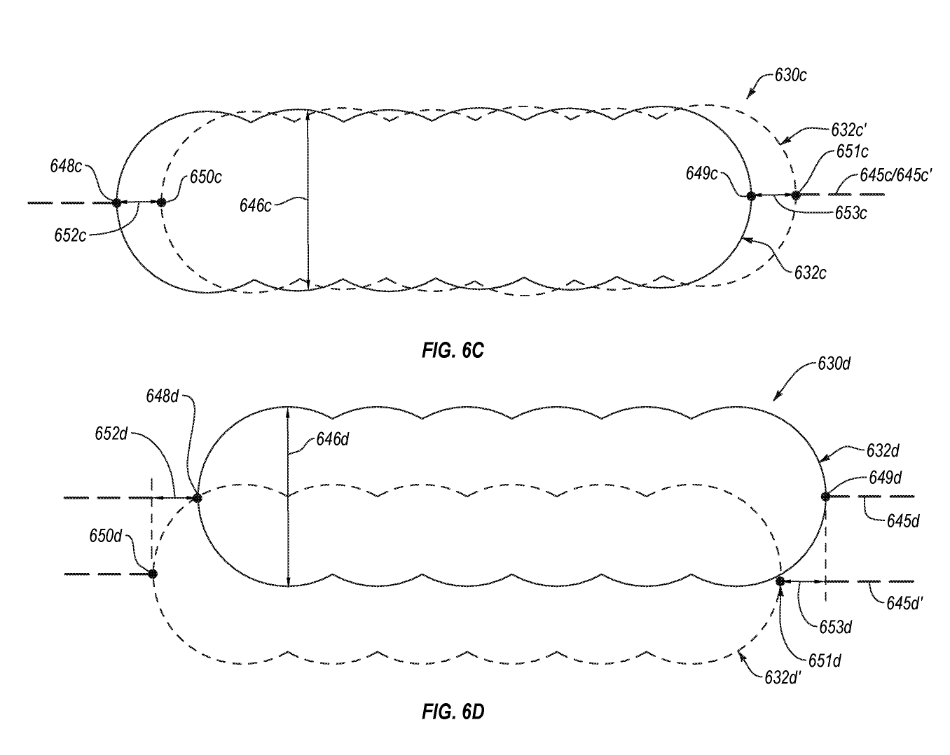

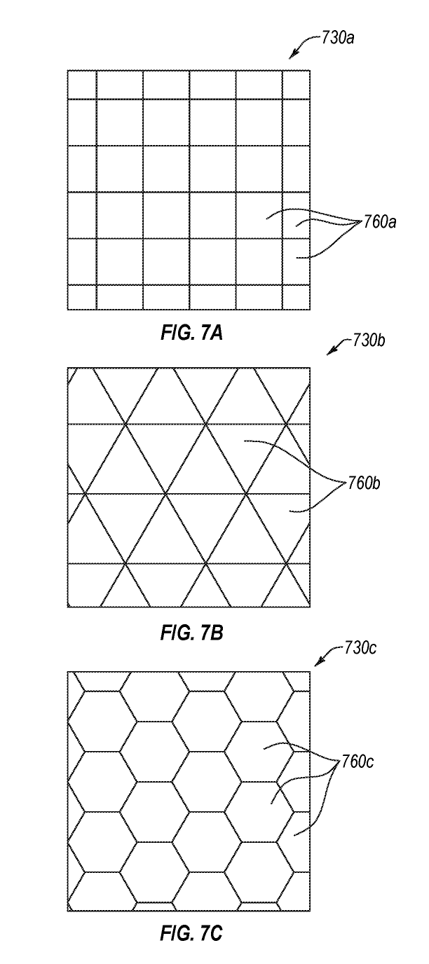

E. Laser Pulse Overlap A beam cross-section of subsequent laser pulses (e.g., the effective area of the laser pulses, or optionally divots, recesses, or formed by such laser pulses, etc. may overlap to improve the surface finish of a surface of a PCD table. FIGS. 6A-6D are schematic top plan views of at least one exterior surface of a PCD table illustrating different methods of forming overlapping energy beams, divots, overlapping recesses, etc., according to different embodiments. The phrase “scan shadow”, as used herein, refers to an area exposed to an energy beam (e.g., a laser beam) or any discernable feature formed by such exposure (e.g., divots, recesses, etc.). The methods shown in FIGS. 6A-6D may be used in any of the PCD tables and/or methods of machining disclosed herein.

FIG. 6A illustrates a method of overlapping adjacent scan shadows recess, according to an embodiment. For example, the method shown in FIG. 6A includes directing a first laser pulse towards the at least one exterior surface of a PCD table. The first laser pulse may exhibit a first scan shadow 640a. The first scan shadow 640a exhibits a first surface area. After the first laser pulse is directed towards a portion of an exterior surface of a PCD table, a second laser pulse may be directed towards another portion of the exterior surface of such PCD table. The portion of the exterior surface that is removed by the second laser pulse is illustrated in FIG. 6A with the scan shadow 644. The first laser pulse may form a first divot exhibiting a first surface area in the exterior surface of the PCD table and the second laser pulse may form a second divot (not shown) exhibiting a second surface area in the exterior surface of the PCD table. The first divot and/or the second divot may be at least partially circular. The first and second divots collectively form a recess (not shown).

The second laser pulse may irradiate and remove PCD material from about 25% to about 99.95% of the first surface area of the scan shadow 640a. For example, the second laser pulse may irradiate and remove PCD material from greater than about 50%, about 30% to about 50%, about 40% to about 60%, about 50% to about 70%, about 60% to about 80%, about 70% to about 90%, about 80% to about 95%, greater than 75%, greater than 90%, or greater than about 95% of the first surface area of the scan shadow 640a. Irradiating and removing PCD material from the first surface area of the scan shadow 640a using any of the above percentages may improve the surface finish of an exterior surface of the PCD table by reducing the size of the ridges formed between the adjacent divots.

In an embodiment, one or more additional laser pulses may be directed towards the exterior surface along a selected length (e.g., to forma a recess). Further, the additional laser pulses may irradiate and remove PCD material from respective surface areas of subsequently formed divot (e.g., the second divots that corresponds to the scan shadow 644) according to any of the above-mentioned percentages. For example, a third laser pulse may irradiate and remove PCD material from 25% to about 99.95% of the second surface area of a second divot formed by a second laser pulse, thereby forming a third divot exhibiting a third surface area. Optionally, a fourth laser pulse irradiate and remove PCD material from 25% to about 99.95% of the third surface area of the third divot formed by the third laser pulse, thereby forming a fourth divot exhibiting a fourth surface area, and so forth.

FIG. 6B illustrates a method of overlapping different scan shadows, according to an embodiment. For example, the method shown in FIG. 6B includes directing a plurality of first laser pulses towards the at least one exterior surface 630b of a PCD table (not labeled for clarity) to form a first scan shadow 632b (shown with solid lines). The first scan shadow 632b may represent a feature from which PCD material has been removed. The first scan shadow 632b may be formed according to the method illustrated in FIG. 6A. The first scan shadow 632b extends along reference line 645b and exhibits a first surface area.

After causing the first scan shadow 632b, the method shown in FIG. 6B further includes directing a plurality of second laser pulses towards the at least one exterior surface 630b to cause a second scan shadow 632b′ (shown with dashed lines). For example, the second scan shadow 632b′ may represent a feature from which PCD material has been removed (e.g., from a portion of the first scan shadow 632b and/or from a portion of second scan shadow 632b′). The second scan shadow 632b′ may be formed according to the method illustrated in FIG. 6A. The second scan shadow 632b′ may extend along reference line 645b′ that is substantially parallel to the reference line 645b.

The second scan shadow 632b′ may overlap the first scan shadow 632b by offsetting the second scan shadow 632b′ relative to the first scan shadow 632b in a direction that is non-parallel (e.g., substantially perpendicular) to the first direction 645b. For example, the plurality of second laser pulses that are used to form the second scan shadow 632b′ may irradiate and/or remove PCD material from about 25% to about 99.95% of the first surface area of the first scan shadow 632b. For example, the second laser pulses may irradiate and remove PCD material from greater than about 50%, about 30% to about 50%, about 40% to about 60%, about 50% to about 70%, about 60% to about 80%, about 70% to about 90%, about 80% to about 95%, greater than 75%, greater than 90%, or greater than about 95% of the first surface area of the first scan shadow 632b. Irradiating and/or removing PCD material from the first surface area of the first scan shadow 632b using any of the above percentages may improve the surface finish of an exterior surface of a PCD table by reducing the size of the ridges formed between the first and second scan shadow 632b and 632b′.

In an embodiment, the first scan shadow 632b exhibits a maximum lateral dimension 646b. The second scan shadow 632b′ is offset in the direction that is non-parallel to the first direction 645b such that the second scan shadow 632b′ overlaps about 25% to about 99.95% the maximum lateral dimension 646b of the first scan shadow 632b. For example, the second scan shadow 632b′ may overlap greater than about 50%, about 30% to about 50%, about 40% to about 60%, about 50% to about 70%, about 60% to about 80%, about 70% to about 90%, about 80% to about 95%, greater than 75%, greater than 90%, or greater than about 95% of the maximum lateral dimension 646b of the first scan shadow 632b.

FIG. 6C illustrates a method of overlapping different scan shadows, according to an embodiment. For example, the method shown in FIG. 6C includes directing a plurality of first laser pulses towards the at least one exterior surface 630c of the PCD table (not labeled for clarity) to form a first scan shadow 632c (shown with solid lines). Except as otherwise disclosed herein the first scan shadow 632c may be the same as or similar to the first scan shadow 632b of FIG. 6B. For example, the first scan shadow 632c may extend along reference line 645c. After forming the first scan shadow 632c, the method shown in FIG. 6C further includes directing a plurality of second laser pulses towards the at least one exterior surface 630c to form a second scan shadow 632c′ (shown with dashed lines). Except as otherwise disclosed herein, the second scan shadow 632c′ may be the same as or similar to the second scan shadow 632b′ of FIG. 6B. For example, the second scan shadow 632c′ may extend along the reference line 645c′ that is substantially parallel to reference line 645c.

The second scan shadow 632c′ may at least partially overlap the first scan shadow 632c. For example, scan shadow 632c′ may be offset relative to the first scan shadow 632c in an x direction. For example, the first scan shadow 632b′ may exhibit a first starting point 648c and a first ending point 649c. Similarly, the second scan shadow 632c′ may include a second starting point 650c and a second ending point 651c. In an embodiment, the first starting point 648c may be spaced from the second starting point 650c by a first offset 652c. In an embodiment, the first ending point 649c may be spaced from the second ending point 651c by a second offset 653c that is the same as or different than the first offset 652c.

The first scan shadow 632c may exhibit a maximum dimension 646c. The first and/or second offset 652c, 653c may be 1% to about 99.95% the width dimension 646c. For example, the first and/or second offset 652c, 653c may be greater or less than about 50%, about 1% to about 25%, about 20% to about 40%, about 30% to about 50%, about 40% to about 60%, about 50% to about 70%, about 60% to about 80%, about 70% to about 90%, about 80% to about 95%, greater than 75%, greater than 90%, or greater than about 95% the maximum width dimension 646c. Offsetting the starting points and/or ending points of the first and second scan shadows 632c, 632c′ using any of the above offsets may improve the surface finish of an exterior surface of the PCD table by reducing the size of the ridges formed between the first and second scan shadows 632c, 632c′.

FIG. 6D illustrates a method of overlapping different scan shadows, according to an embodiment. In particular, FIG. 6D illustrates a method of overlapping scan shadows that is a combination of the methods illustrated in FIGS. 6B and 6C. As such, except as otherwise disclosed herein, the first scan shadow 632d may be the same as or similar to the first scan shadows 632b, 632c of FIGS. 6B-6C. For example, the first scan shadow 632d extends along reference line 645d, includes a first starting point 648d and a first ending point 649d, and exhibits a maximum width dimension 646d and a first surface area. Additionally, except as otherwise disclosed herein, the second scan shadow 632d′ is the same as or similar to the second scan shadows 632b′, 632c′ of FIGS. 6B-6C. For example, the second scan shadow 632d′ extends along reference line 645d′ that is substantially parallel to the reference line 645d and exhibits a second starting point 650d and a second ending point 651d.

The second scan shadow 632d′ may overlap the first scan shadow 632d by offsetting the second scan shadow 632d′ relative to the first scan shadow 632d in both x and y directions. As such, the second scan shadow 632d′ may cause removal of PCD material from a first surface area of the first scan shadow 632d according to the method illustrated in FIG. 6B, according to any of the percentages disclosed relative thereto. Additionally, the second scan shadow 632d′ may exhibit a first and/or second offset 652d, 653d similar to the first and/or second offset 652c, 653c described relative to FIG. 6C. The method illustrated in FIG. 6D may improve the surface finish of an exterior surface 630d of a PCD table by reducing the size of the ridges formed by the first scan shadow 632d.

Increasing any of the area of overlap embodiments between successive scan shadows disclosed herein may improve the surface finish of the exterior surface of an PCD table. However, it may also increase the time required to machine the PCD table. As such, in an embodiment, any of the overlap disclosed herein may vary as the PCD table is machined. For example, the initial overlap between successive scan shadows may initially be relatively small, however, the overlap may be increased as subsequent PCD material is removed. For example, one or more first scan shadow of PCD material may be removed from the PCD table using a first overlap area (e.g., removal of PCD material from a first selected percentage of a surface area of a scan shadow) and one or more second scan shadows of PCD material may be removed after the first scan shadows using a second overlap area that is greater than the first overlap area (e.g., removal of PCD material from a second selected percentage of a surface area of a scan shadow that is greater than the first selected percentage).

F. Removing PCD Material from a Plurality of Distinct Regions

The amount of PCD material removed from a PCD table may vary depending on a plurality of different factors. For example, each laser pulse exhibits a focal length. Theoretically, each laser pulse removes the greatest amount of PCD material when the exterior surface of the PCD table is at the focal length. However, each laser pulse removes less diamond material when the exterior surface is positioned further from the focal point. As such, each laser pulse exhibits an operable focal range, which is the distance from the exterior surface to the focal length at which an acceptable amount of PCD material is removed from the PCD table. The acceptable amount of PCD material may be at least 10%, at least 25%, at least 50%, at least 75%, at least 80%, at least 85%, at least 90%, at least 95%, at least 97.5%, or at least 99% the amount of PCD material removed when the exterior surface is at the focal length. The operable focal range (e.g., the distance from the focal length) may be greater than about ±1 nm, such as about ±10 nm to about ±100 nm, about ±50 nm to about ±500 nm, about ±250 nm to about ±1 μm, about ±750 nm to about ±5 μm, about ±1 μm to about ±5 μm, about ±5 μm to about ±50 μm, or greater than about ±50 μm. The operable focal range may be less than ±10% of the focal length, such as less than about ±5%, less than about ±2.5%, about ±0% to about ±2%, about ±1% to about ±3%, about ±2.5% to about ±5%, about ±4% to about ±7%, or about ±5% to about ±10% of the focal length.

In another embodiment, each laser pulse removes the greatest amount of PCD material when the angle between the laser pulse and the exterior surface of the PCD table is about 90°. However, each laser pulse removes less PCD material when the angle between the laser pulse and the exterior surface (measured as the smallest angle between the laser direction and a planar PCD surface or the smallest angle between the laser direction and a slope of a plane or a curved surface) deviates from 90°. As such, each laser pulse exhibits an operable angle range which is the angle between the exterior surface and the laser pulse at which an acceptable amount of PCD material is removed from the PCD table. The operable angle range may be about 45° to about 90°, such as about 60° to about 90°, about 75° to about 90°, about 80° to about 90°, about 85° to about 90°, about 86° to about 90°, about 87° to about 90°, about 88° to about 90°, about 89° to about 90°, or about 89.5° to about 90°.

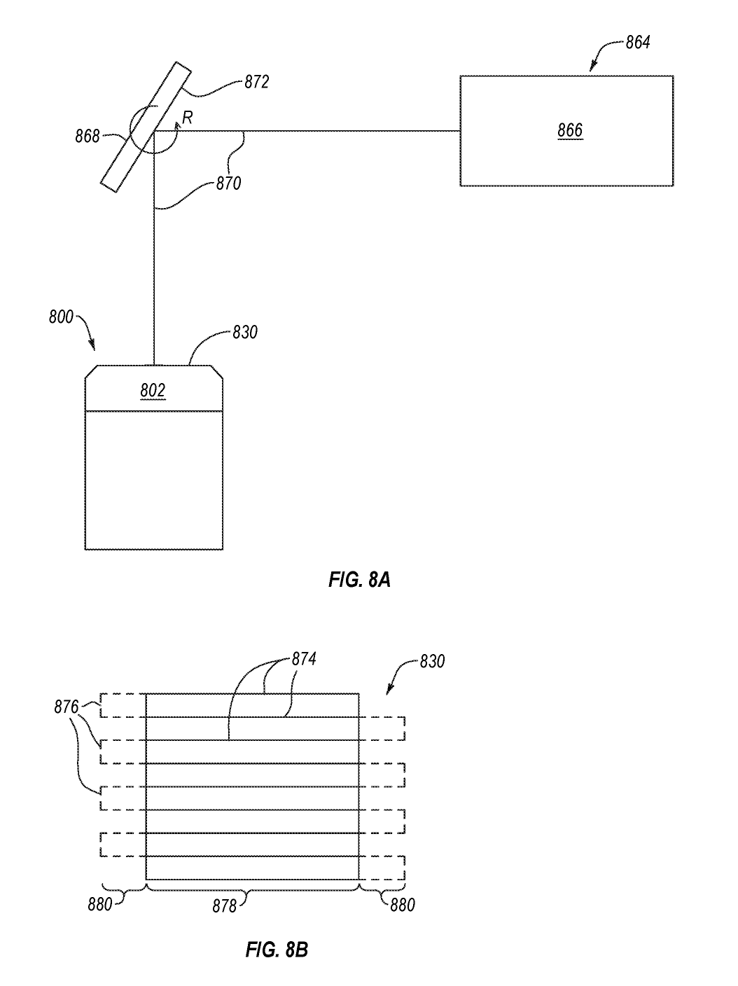

In an embodiment, the exterior surface of the PCD table may be large enough that removing a layer/volume of PCD material from the entire exterior surface may result in portions of the exterior surface being outside of the operable focal range and/or outside of the operable angle range. This may result in concave surfaces and/or different removal rates of the PCD material. One solution is to continuously move the laser device, the PCD table, or employ galvo mirrors (galvo mirrors 868 of FIG. 8A) such that the exterior surface is continuously within the operable focal range and operable angle range. However, such movements may create delays, require expensive equipment, and/or may limit the surface finish due to inherent vibrations caused during the movements.

One solution is to subdivide the exterior surface of the PCD table into a plurality of distinct regions. Each region exhibits a shape and size that enables the entire region to be within the operable focal length and/or the operable angle range. This enables each region to have one or more layers/volumes of PCD material removed therefrom one at a time without requiring the laser device, the PCD table, or the galvo mirrors from being moved while actively removing PCD material. As such, the thickness of each layer/volume of PCD material removed from each distinct region of the PCD table remain relatively constant (e.g., varies by at most 75%, at most 50%, at most 25%, at most 15%, at most 10%, at most 5%, at most 2%, at most 1%, or at most 0.5%). After the one or more layers/volumes are removed from the first region, the laser pulses may be prevented from impacting the PCD table (e.g., the laser device is turned off) and the PCD table and/or the laser device are moved such that second region of the exterior surface is within the operable focal range and/or operable angle range. The laser pulses are then allowed to impact the PCD table to remove one or more layers/volumes of PCD material from the second region.

The entire exterior surface may be subdivided into a plurality of regions. For example, the plurality of regions may be contiguous with each other and/or may exhibit continuous edges (e.g., do not overlap and/or create gaps therebetween). Such a configuration may ensure that the PCD material removed therefrom is relatively consistent over the entire exterior surface.

In an embodiment, at least some of the plurality of regions may exhibit at least one of the same shape, size, or orientation. In an embodiment, at least two of the plurality of regions may exhibit at least one of a different shape, size, or orientation. In an embodiment, one or more first layers/volumes of PCD material may be removed using a first pattern of regions and one or more second layers/volumes of PCD material may be removed using a second pattern of regions that is different than or offset relative to the first pattern of regions.

FIGS. 7A-7H are top views of a portion of an exterior surface of a PCD table that is subdivided into distinct regions, according to different embodiments. Except as otherwise described herein, the PCD tables and their materials, components, elements or methods of machining (e.g., machining) may be similar to or the same as the PCD tables 202a-i, 302, 402a-b, 502a-b (FIGS. 1-5B) and their respective materials, components, elements, or methods of machining the PCD table. The PCD tables of FIGS. 7A-7H or their materials, components, elements, or methods of machining the PCD tables may be used in any of the PCD tables or methods of machining the PCD tables disclosed herein.

FIG. 7A shows an exterior surface 730a that is subdivided into a plurality of regions 760a, each of which exhibits a generally rectangular (e.g., generally square) shape. As illustrated in FIG. 7A, at least some of the plurality of regions 760a exhibits substantially the same size/area and regions 760a are collectively arranged to form a grid-like pattern. However, it is noted that regions 760a may be arranged and/or sized in any suitable manner. For example, at least one row of the regions 760a may be offset relative to an adjacent row of the regions 760a such that the regions 760a do not form continuous columns. In another embodiment, at least one column of the regions 760a may be offset relative to an adjacent row of the regions 760a such that the regions 760a do not form continuous rows. In another embodiment, at least one of the regions 760a may exhibit a size that is larger or smaller than another region 760a. In another embodiment, at least a portion of the regions 760a may be arranged in a non-grid-like pattern (e.g., randomly positioned, sized, and/or oriented). In an embodiment, each of the recesses or scan shadow formed by removing PCD material from one of the regions 760a may exhibit the same length (e.g., thereby making it easier to determine the correct delays.

FIG. 7B shows an exterior surface 730b subdivided into a plurality of regions 760b each of which exhibits a generally triangular or partially triangular shape. As illustrated in FIG. 7B, at least some of the regions 760b may exhibit the same size/area and are arranged to form a grid-like pattern. However, similar to the regions 760a (FIG. 7A), at least one of the rows may be offset relative to an adjacent row, at least one of the regions 760b may be larger or smaller than another region 760b, and/or at least a portion of the regions 760b may form a non-grid-like pattern.

Referring to FIG. 7C, an exterior surface 730c is subdivided into a plurality of regions 760c each of which exhibits a generally hexagonal or partially hexagonal shape. As illustrated in FIG. 7C, at least some of the regions 760c may exhibit the same size/area and are arranged to form a grid-like pattern. However, similar to the regions 760a (FIG. 7A), at least one of the rows may be offset relative to an adjacent row, at least one of the regions 760b may be larger or smaller than another region 760b, and/or at least a portion of the regions 760c may form a non-grid-like pattern.

FIGS. 7A-7C illustrate examples of different shapes that may be contiguous (e.g., do not form gaps and/or overlap). However, it is understood that the regions disclosed herein may exhibit a plurality of different shapes that are contiguous, such as other polygonal shapes (e.g., trapezoids), non-equilateral non-equiangular pentagonal shapes, etc.

In an embodiment, the regions disclosed herein may exhibit a plurality of different shapes. FIG. 7D shows an exterior surface 730d subdivided into a plurality of regions that exhibit different shapes. For example, the exterior surface 730d may be subdivided into a plurality of first regions 760d that exhibit a generally pentagonal shape and a plurality of second regions 760d′ that exhibit a generally polygonal shape (e.g., generally diamond shape). However, it is noted that the first and second regions 760d, 760d′ may exhibit any shapes without limitation. Forming the regions from a plurality of shapes allows that regions to exhibit shapes that do not nest by themselves (e.g., circles with hypocycloids, equilateral and/or equiangular pentagons with diamonds). As shown in FIG. 7D, the first and second regions 760d, 760d′ form a grid-like pattern. However, the first and second regions 760d, 760d′ may be arranged in any suitable manner. For example, FIG. 7E illustrates an exterior surface 730e that includes a plurality of first and second regions 760e, 760e′ arranged about a central point 762.

FIG. 7F shows an exterior surface 730f subdivided into a plurality of first regions 760f. In the illustrated embodiment, each of the first regions 760f exhibits a generally rectangular shape. However, it is noted that first regions 760f may exhibit any of the shapes or plurality of shapes disclosed herein. PCD material may be removed from each of the first regions 760f by forming a plurality of first recesses 732f with a laser. The first recesses 732f may be substantially parallel to each other.

Referring to FIG. 7G, after a selected amount of PCD material has been removed by forming first recesses 732f in the first regions 760f (the first regions 760f and the first recesses 732f are shown using dashed lines), the at least one exterior surface 730f may be subdivided into a plurality of second regions 760g. As shown in FIG. 7G, four second regions 760g subdivide each first region 760f. In an embodiment, each of the second regions 760g exhibits a substantially similar shape, size, and orientation as each first regions 760f. In an embodiment, each of the second regions 760g may exhibit at least one of a different shape, size, or orientation than the first regions 760f. PCD material may be removed from each of the second regions 760g by forming a plurality of second recesses 732g (shown using solid lines with a laser). The second recesses 732g may be substantially parallel to each other.

In an embodiment, the second recesses 732g may be non-parallel to the first recesses 732f. For example, forming the second recesses 732g at a non-parallel angle relative to the first recesses 732f to reduce, inhibit, or prevent the second recesses 732g from reinforcing channels and/or ridges formed by the first recesses 732f. For example, the second recesses 732g may extend relative to the first recesses 732f at any of the angles θ disclosed herein.

In an embodiment, removing PCD material by forming recesses within first regions 760f may create ridges or channels between at least some of the first regions 760f. For example, channels and/or ridges may be formed between at least some of the first regions 760f. To compensate for these channels and/or ridges and improve the surface finish, the second regions 760g may be offset relative to the first regions 760f. For example, second regions 760g may be offset relative to the first regions 760f by at least one of an x-direction offset 748g and/or a y-direction offset 752g. The x-direction offset 748g may be about 1% to about 99.95% (e.g., about 1% to about 10%, about 5% to about 25%, about 20% to about 40%, about 30% to about 50%, about 40% to about 60%, about 55% to about 75%, about 70% to about 90%, or about 80% to about 99%) a maximum dimension of the first and/or second regions 760f, 760g that extends in the x-direction. The y-direction offset 752g may be about 1% to about 99.95% (e.g., about 1% to about 10%, about 5% to about 25%, about 20% to about 40%, about 30% to about 50%, about 40% to about 60%, about 55% to about 75%, about 70% to about 90%, or about 80% to about 99%) a maximum dimension of the first and/or second regions 760f, 760g that extends in y-dimension.

FIG. 7H shows an exterior surface 730h subdivided into a plurality of regions 760h. For example, the plurality of regions 760h may be substantially similar to the first and/or second regions 760f, 760f′ (FIGS. 7F-7G). For example, each of the regions 760h have PCD material removed therefrom by forming substantially parallel recesses 732h. However, the recesses 732h may be non-parallel to the recesses 732h, 733h, and 735h of adjacent regions 760h, respectively.

Referring to FIGS. 7A-7H, after the PCD table is machined, the recesses and/or the pattern of regions formed by removal of PCD material from the PCD table may be observable thereby forming at least a part of an observable rastering pattern including a microfeatures. Similarly, remnants and/or shadows of the recesses and/or pattern of regions due to removal of PCD material from the PCD table prior to the most recent scanning or rastering of each of the regions may also be observable thereby forming at least a portion of the observable rastering pattern including one or more microfeatures.

### G. Removing PCD Material Using a Plurality of Divots

As previously discussed, PCD material can be removed using a plurality of divots. In an embodiment, at least some of the plurality of divots do not form a plurality of recesses. In such an embodiment, the divots can be used to form intricate patterns that could not be formed with recesses. For example, the divots can be used to form an image on the at least one exterior surface using a method that is similar to how pixels form bitmap images. In such an example, the divots can form a selected rastering pattern in the exterior surface where the rastering pattern forms an image or word. In another example, the divots can be randomly positioned in the at least one exterior surface. In either example, the density of the divots may vary on the exterior surface which may cause the surface finish of the exterior surface to be controllably and selectively varied depending on the application of the PCD material.

In an embodiment, at least some of the plurality of divots that are used to remove PCD material may exhibit different parameters. For example, at least some of the divots may be formed from energy beams or energy pulses that irradiated the at least one exterior surface (e.g., a planar exterior surface) at a first angle while other divots may be formed from energy beams or energy pulses that irradiated that at least one exterior surface a second angle that is different than the first angle. Forming the divots with energy beams or energy pulses that irradiated the at least one exterior surface at different angle can affect how the light reflects off the exterior surface and/or how much PCD material is removed from the PCD material. In another example, the energy beams or energy pulses that form some of the divots may exhibit a different pulse duration or intensity that is different than other energy beams or energy pulses that form other divots. In such an example, the depth of the divots and the surface finish of the exterior surface may be controllably and selectively varied. In another example, the energy beams or energy pulses that form some of the divots may exhibit a Gaussian energy distribution while energy beams or pulses that forms other divots may exhibit a top-hat energy distribution. In such an example, the surface finish and/or the depth of the divots may be controllably and selectively varied.

H. Delays FIG. 8A is a schematic illustration of a system 864 that is configured to machine at least one exterior surface 830 of a PCD table 802 of a PDC 800, according to an embodiment. The system 864 includes a laser device 866 and at least one galvo mirror 868. The system 864 may be used to machine any of the PCD's disclosed herein.

In an embodiment, the laser device 866 may be configured to perform any of the laser machining methods disclosed herein. For example, the laser device 866 may be configured to emit a plurality of laser beams/pulses 870 exhibiting a generally top-hat energy distribution, a plurality of laser pulses exhibiting any of the laser characteristics disclosed herein, etc. For example, the laser device 866 may be a CLPF and CLPFT Femtosecond Pulsed Cr:ZnSe/S Mid-IR Laser from IPG, an ELPP-1645-10-100-20 Er:YAG Fiber Pumped Modelocked Laser from IPG, a PicoBlade® Picosecond Micromachining Laser from Lumentum, a YLPP-R Series Ytterbium Picosecond Fiber Laser from IPG, a Ytterbium Pulsed Fiber Laser Model YLP-HP-1-100-200-200 from IPG, a Ytterbium Pulsed Fiber Laser Model YLP-V2-1-100-100-100 from IPG, or another suitable laser device.

As previously discussed, the system 864 includes at least one galvo mirror 868 (e.g., two mirrors, three or more mirrors). The galvo mirror 868 may be incorporated into the laser device 866 or may be spaced from the laser device 866. The galvo mirror 868 is positioned to have a laser beam/pulse 870 emitted by the laser device 866 reflect off surface 872 thereof. The reflective surface 872 of the galvo mirror 868 is configured to reflect the laser beam/pulse 870, while absorbing substantially none of energy of the laser pulse 870.

The galvo mirror 868 exhibits at least one degree of freedom. For example, the galvo mirror 868 may be configured to rotate about at least one rotation axis R (e.g., one of pitch, yaw, or roll). However, the galvo mirror 868 may rotate about two rotation axes, rotate about three rotation axes, translate in the x-direction, translate in the y-direction, or translate in the z-direction, or a suitable combination of the foregoing. Movement of the galvo mirror 868 changes the location of the laser beam on the exterior surface 630 of the PCD table 602 (e.g., a position that is machined using the laser pulses 870). For example, movement of the galvo mirror 868 may cause the laser to raster the exterior surface 830, change the angle between a plurality of first recesses formed by removing PCD material and a plurality of second recesses formed by removing additional PCD material (FIG. 3B), cause the offsets shown in FIGS. 6A-6D, to machine different regions of the exterior surface 830 as shown in FIGS. 7A-I, or perform any of the machining embodiments disclosed herein.

However, movement of the galvo mirrors 868 may require delays to form surface finishes disclosed herein. Failure to configure delays correctly can result in at least one of variation in the amount of PCD material removed within a recesses (e.g., incorrect laseron and/or laseroff delays, poly delays that are too long), failure to complete recesses (e.g., mark delays that are too short), formation of recesses on the wrong portion of the exterior surface 830 (e.g., jump delays that are too short, mark delays that are too short), inability to form sharp angles (e.g., poly delays are too short), create burn-in effects (e.g., poly delays are too long, laseron delays are too short), and/or increase the time required machine the PCD table 802. The delays may be needed to compensate for the lag between the movement of the galvo mirror 868 and the laser device 866, the lag and settling time required to accelerate to an intended velocity and/or decelerate from an intended velocity of the galvo mirror 868, the time lag required to change between different markings, or variations in intensity of the laser pulses. As such, the methods disclosed herein may include at least one of jump delays, mark delays, poly delays, laseron delays, or laseroff delays that are selected to reduce or prevent at least some of the above-mentioned problems (e.g., of such that the exterior surface 830 of the PCD table may exhibit any of the surface finishes disclosed herein).

In an embodiment, the system 864 may be configured to move the galvo mirror 868 in a manner that reduces or eliminates the need for at least one of the delays discussed above. Such a configuration may reduce and/or eliminate the risk of using inadequate delays. FIG. 8B is a schematic view of at least a portion of the exterior surface 830 of the PCD table 802 showing the path of the laser beam/pulses 870 on and near the exterior surface 830. The portion of the exterior surface 830 shown in FIG. 8B may be the entire exterior surface 830 or a region of the exterior surface similar to the regions shown in FIGS. 7A-7H. For example, while FIG. 8B illustrates that the exterior surface 830 is square, it is understood that the exterior surface 830 may be circular, triangular, pentagonal, irregular, or any other suitable shape, such as any of the shapes of the regions shown in FIGS. 7A-7H. The energy beam techniques illustrated in FIG. 8B may be used in any of the methods disclosed herein.

The galvo mirrors 868 may be configured to move such that the path of the laser beam/pulses 870 forms at least a plurality of first lines 874 and a plurality of second lines 876. The plurality of first lines 874 may be substantially parallel to each other. In an embodiment, the plurality of first lines 874 include a plurality of parallel lines, a plurality of congruent curved lines, a plurality of sinusoidal lines, a plurality of wobbly lines, or any other suitable lines, paths, or patterns, without limitation.

Each of the first lines 874 includes a middle portion 878 and two starting/ending portions 880. The starting/ending portions 880 extend from the second lines 876 to the middle portion 878 and the middle portion 878 extends between the two starting/ending portion 880. The plurality of second lines 876 may extend between the starting/ending portions 880 of adjacent first lines 874. It is noted that the plurality of first fines 874 may overlap using any of the overlap techniques disclosed herein.

FIG. 8B illustrates that the middle portions 878 of the first lines 874 remove PCD material from at least a portion of the upper surface 830 of the PCD table 802. For example, the middle portions 878 of the first lines 874 may remove PCD material from an entirety of the upper surface 830. In another example, the middle portions 878 of the first lines 874 may remove PCD material from a portion of the upper surface 830. For example, the middle portions 878 of the first lines 874 may remove PCD material from a segment of the upper surface 830 of the PCD table 802, such as any one of the segments illustrated in FIGS. 7A-7H. In another example, the middle portions 878 of the first lines 874 may remove PCD material from the portion of the PCD material using the methods shown in FIGS. 2A-2L. In another example, the middle portion 878 can include at least a portion of the lateral surface of the PCD table 830 or a substrate.

In an embodiment, the system 864 shown in FIG. 8A may be configured to irradiate the exterior surface with laser beams/pulses 870 such that the recesses formed in the exterior surface 830 are formed at a substantially constant velocity. This may allow the amount of PCD material removed to be substantially constant along the recesses. However, the galvo mirror 868 may need to come to a complete stop or at least decelerate after forming one of the first lines 874 and may need to accelerate before forming the next first line 874. Decelerating and accelerating the galvo mirror 868 from or to an intended velocity, respectively, may vary the amount of PCD material removed by each laser pulse.

As such, referring to FIG. 8B, the starting/ending portions 880 are selected to allow the galvo mirrors 868 to accelerate to and decelerate from an intended velocity. For example, an energy beam (e.g., a laser beam, a laser pulse, etc.) may irradiate the exterior surface 830 as it moves across the exterior surface 830 at a substantially constant speed along the middle portion 878 of each first line 874. The galvo mirror 868 may be controlled to exhibit a selected intended velocity when the system 864 starts and stops removing PCD material from the PCD table 802. For example, the system 864 may stop irradiating the exterior surface 830 (e.g., the laser device 866 turns off) when the laser beam/pulses 870 would irradiate the starting/ending portions 880. This is because the galvo mirror 868 is accelerating and decelerating when the laser beam/pulses 870 travel along starting/ending portions 880 and the second lines 876. As such, the laser pulses 870 may be controlled to irradiate the exterior surface 830 only when the laser beam/pulses 870 are moving at a substantially constant velocity, thereby ensuring that each laser beam/pulse removes substantially the same amount of PCD material. This may improve the consistency of the machining of the PCD table and may improve the surface finish of the exterior surface 830.

As previously discussed, the method shown in FIG. 8B may be used to reduce or eliminate the need for at least some of the delays, such as the poly delay or the mark delay.

### I. Secondary Processing

In an embodiment, any of the PCD tables disclosed herein may be machined using non-energy-beam techniques after the PCD table has been machined using an energy beam technique. For example, the non-energy-beam technique may be used to further improve a surface finish of the PCD table. In another embodiment, the non-energy-beam technique may more efficient (e.g., quicker, cheaper), especially at relatively fine surface finishes, than using an energy beam technique.

In an embodiment, a PCD table may be further machined using a honing technique. The honing technique may include removing PCD material from an exterior surface of the PCD table using a honing material. The honing material exhibits a highly friable abrasive and/or weak bonds. As such, the honing material wears preferential relative to the PCD table. The preferential wear of the honing material allows the honing material to conform to the surface of the PCD material and to remove a relatively small amount of PCD material. Additionally, the honing material may leave a cross-hatched or randomly oriented scratches in the exterior surface of the PCD table that is being removed. In an embodiment, the honing technique may be performed using a CNC machining device, a rotating wheel, a honing wheel, or a manual device.

In an embodiment, a PCD table may be further machined using a polishing or lapping technique. The polishing/lapping technique may be performed using vibratory tools, lapping tools, manual tools, ultrasonic polishing tools, or other devices that are configured to polish or lap a superhard material. For example, the tools used to further machine the PCD table may include an abrasive material (e.g., diamond powder). To minimize damage to the PCD table, the PCD table may be machines using relatively slow infeed rates.

In an embodiment, a PCD table may be further machined using a brushing technique. The brushing technique may include a brush (e.g., an aluminum brush) that is coated with an abrasive material or includes abrasive materials disposed therein. The brushing technique may include rubbing the brush against at least one exterior surface of the PCD table.

In an embodiment, a PCD table may be further machined using loose abrasives or pastes. Loose abrasives includes abrasive particles that are not combined in a liquid medium (e.g., oil, water, or paste) whereas the pastes includes abrasive particles that are combined in a liquid medium. The loose abrasives and/or the pastes may contact against an exterior surface of the PCD table to further machine the PCD table. For example, the loose abrasive and/or pastes may be used in the honing, polishing, or brushing techniques disclosed above.

In an embodiment, the PCD table may be further machined using pads. The pads include a fibrous material having an abrasive material dispersed therein. The pads may exhibit any shapes, such as a circular or square shape. The pads may contact against at least one exterior surface of the PCD table to further machine the PCD table. For example, the pads may be used in the honing, polishing, or brushing techniques disclosed above. In another example, the pads may be used with the loose abrasives and/or pastes disclosed above.

In an embodiment, the PCD table may be further machined using a vitrified or resin bonded materials. The vitrified or resin bonded materials may include abrasive particles disposed in a matrix and may be used to form a grinding or polishing wheel, a grinding or polishing pad, a brush, or another device. The vitrified or resin bonded materials may contact against at least one exterior surface of the PCD table to further polishing and/or shape the PCD table. The vitrified or resin bonded material may be used in the honing, polishing, lapping, or brushing techniques disclosed above.

### IV. Shapes of PCD Tables that May be Formed Using the Methods Disclosed Herein

It is understood that the methods (e.g., laser techniques, secondary processing techniques, etc.) disclosed herein may be used for form PCD tables exhibiting any suitable shape. For example, the methods disclosed herein may be used to form PCD tables that would be difficult or impossible to form using grinding, lapping, EDM, or other conventional shaping techniques. Additionally, the methods disclosed herein may be used to machine any exterior surface of the PCD tables to any of the surface finishes disclosed herein, including exterior surfaces that would be difficult or impossible to machine using grinding, lapping, EDM, or other conventional machining techniques. FIGS. 9A-9G illustrate shapes and/or surfaces that may be machined in a PCD table using any of the laser machining methods disclosed herein that would be difficult to machine using conventional machining or shaping techniques, according to different embodiments. However, it is understood that the machining techniques disclosed herein may be used to machine PCD tables in other suitable shapes, topographies, configurations, or geometries without limitations.

FIGS. 9A and 9B are top plan and cross-sectional views, respectively, of a PDC 900a that includes a PCD table 902a that is machined using any of the laser techniques disclosed herein, according to an embodiment. For example, the PCD table 902a may include at least one lateral surface 908a and an uppermost exterior surface 910a. The PCD table 902a may also include an outermost chamfer 912a extending between the lateral surface 908a and the uppermost exterior surface 910a. In an embodiment, at least one of the lateral surface 908a, the uppermost exterior surface 910a, or the outermost chamfer 912a may be machined using any of the machining techniques disclosed herein. In an embodiment, at least one of the lateral surface 908a, the uppermost exterior surface 910a, and/or the outermost chamfer 912a may be machined using at least one conventional machining technique.

The PCD table 902a also includes at least one concave portion 920a. The concave portion 920a is collectively defined by at least one lowermost exterior surface 928a having at least a portion thereof closer to the interfacial surface 906a than the uppermost exterior surface 910a and at least one inner transition surface 926a extending from the uppermost exterior surface 910a and the lowermost exterior surface 928a. The concave portion 920a may exhibit a depth Da, measured from the uppermost exterior surface 910a to the lowermost exterior surface 928a. The depth Da may be at least about 25 μm, such as about 25 μm to about 125 μm, about 50 μm to about 175 μm, about 150 μm to about 300 μm, about 250 μm to about 500 μm, or about 400 μm to about 1 mm, or greater than about 1 mm.

The inner transition surface 926a may include a chamfer (as shown in FIG. 9B), a curved surface, or any of the other inner transition surfaces disclosed herein. The lowermost exterior surface 928a may exhibit any suitable topography, such as substantially planar, concave curvature, or convex curvature. In an embodiment, the lowermost exterior surface 928a may exhibit a generally circular shape or any other suitable shape. Similar, the inner transition surface 926a may exhibit a conical shape that, at least an innermost portion thereof, meets the lowermost exterior surface 928a. The concave portion 920a may modify the residual stresses, affect the leaching characteristics (e.g., leach time, leach profile), and/or improve the thermal stability (e.g., the increased surface area may improve heat removal) of the PCD table 902a.

Due to the concave nature of the concave portion 920a, conventional machining techniques may be limited or may be incapable of forming (e.g., polish and/or form) the concave portion 920a. However, the laser machining methods disclosed herein may be used to form and/or polish the concave portion 920a (e.g., polish at least one of the lowermost exterior surface 928a or the inner transition surface 926a). Additionally, the laser techniques disclosed herein may be used to form relatively sharp angles between the lowermost exterior surface 928a and the inner transition surface 926a and between the inner transition surface 926a and the uppermost exterior surface 910a. The relatively sharp angles may exhibit a radius of curvature that is less than 100 μm, such as less than 10 μm, less than 1 μm, or less than 100 nm. However, in some embodiments, at least a portion of the concave portion 920a may be formed and/or at least one of the lowermost exterior surface 928a or the inner transition surface 926a may be formed using conventional techniques.

FIGS. 9C and 9D are top plan and cross-sectional views, respectively, of a PDC 900c that includes a PCD table 902c that is machined using any of the laser techniques disclosed herein, according to an embodiment. Except as otherwise disclosed herein, the PCD table 902c and its materials, elements, components, and methods of machining may be the same as or similar to the PCD table 902a (FIGS. 9A-9B) and its respective materials, components, element, or methods of machining.

The PCD table 902c may include at least one lateral surface 908c, an uppermost exterior surface 910c, and, optionally, an outermost chamfer 912a extending between the lateral surface 908a and the uppermost exterior surface 910a. The PCD table 902c also includes at least one concave portion 920c that is collectively defined by at least one lowermost exterior surface 928c and at least one inner transition surface 926c extending from the uppermost exterior surface 910c and the lowermost exterior surface 928c. The concave portion 920c may exhibit a depth Dc that is measured from the uppermost exterior surface 910c to the lowermost exterior surface 928c. The depth Dc may be the same as Da illustrated in FIG. 9B. The lowermost exterior surface 928c may exhibit a generally elliptical shape or any other suitable shape (e.g., the generally circular shape shown in FIG. 9B). Additionally, the inner transition surface 926c may form a substantially vertical surface or another suitable topography (e.g., tapered, curved). The concave portion 920c may modify the residual stresses, affect the leaching characteristics, and/or improve the thermal stability of the PCD table 902a.

Due to the concave nature of the concave portion 920c, conventional machining techniques may be limited or may be incapable of forming the concave portion 920c. As such, the laser machining methods disclosed herein may be used to at least one of form the concave portion 920c, polish the surfaces of the concave portion 920c, or form sharp angles. However, in some embodiments, at least a portion of the concave portion 920c may be machined using conventional techniques, including, without limitation, forming at least a portion of the concave portion 920c during HPHT sintering of PCD table 902c.

FIGS. 9E and 9F are top plan and cross-sectional views, respectively, of a PDC 900e that includes a PCD table 902e that is machined using any of the laser techniques disclosed herein, according to an embodiment. Except as otherwise disclosed herein, the PCD table 902e and its materials, elements, components, and methods of machining may be the same as or similar to the PCD table 902a, 902c (FIGS. 9A-9D) and their respective materials, components, element, or methods of machining.

The PCD table 902e may include at least one lateral surface 908e, an uppermost exterior surface 910e, and, optionally, an outermost chamfer (not shown). The PCD table 902e also includes at least one concave portion 920e that is collectively defined by at least one lowermost exterior surface 928e and a plurality of inner transition surfaces formed a stepped surface that extends from the uppermost exterior surface 910e and the lowermost exterior surface 928e. The stepped portion may include a plurality of relatively vertical surfaces 988e and at least one relatively horizontal surface 990e. Each of the stepped portions may exhibit a depth De measured from the horizontal surface 990e to the uppermost exterior surface 910c or an immediately adjacent horizontal surface 990e. The depth De may exhibit any of the same depths as Da shown in FIG. 9B. The concave portion 920e may also exhibit a total depth Dt measured from the uppermost exterior surface 920e to the lowermost exterior surface 928e and may be greater than about 50 μm, such as about 50 μm to about 250 μm, about 100 μm to about 500 μm, about 400 μm to about 1 mm, or greater than about 1 mm. The lowermost exterior surface 928e may exhibit a generally rectangular or square shape, or another suitable shape. The relatively vertical and horizontal surfaces 988e, 990e may form annular surface that may or may not correspond to the shape of the lowermost exterior surface 928e. The concave portion 920e may modify the residual stresses, affect the leaching characteristics, and/or improve the thermal stability of the PCD table 902e.

Due to the concave nature of the concave portion 920e, conventional machining techniques may be limited or may be incapable of forming the concave portion 920e. As such, the laser machining methods disclosed herein may be used to at least one of form the concave portion 920e, polish the surfaces of the concave portion 920e, or form sharp angles between adjacent surfaces. However, in some embodiments, at least a portion of the concave portion 920e may be machined using conventional machining techniques.

FIG. 9G is an isometric view of a PDC 900g that includes a PCD table 902g that is machined using any of the laser techniques disclosed herein, according to an embodiment. Except as otherwise disclosed herein, the PCD table 902g and its materials, elements, components, and methods of machining may be the same as or similar to the PCD table 902a, 902c, 902e (FIGS. 9A-9F) and their respective materials, components, element, or methods of machining.

The PCD table 902g includes at least one lateral surface 908g and at least one uppermost exterior surface 910g. The uppermost exterior surface 910g may exhibit any suitable topography, such as a planar, angular, or curved topography. The PCD table 902g also includes at least one concave portion 920g. In the illustrated embodiment, the at least one concave portion 920g includes a plurality of concave portions 920g and each of the plurality of concave portions 920g extends from the lateral surface 908g towards a center 991g of the PCD table 902g. However, at least one of the plurality of concave portions 920g may not extend inwardly from the lateral surface 908g and instead may be at least partially or completely surrounded by the uppermost exterior surface 910g (e.g., as shown in FIGS. 9A, 9C, and 9E). In an embodiment, the PCD table 902g only includes a single concave portion 920g. The concave portion 920g may at least one of modify the residual stresses, affect the leaching characteristics, or improve the thermal stability of the PCD table 902g.

In an embodiment, the at least one concave portion 920g is collectively defined by at least one lowermost exterior surface 928g and at least one inner transition surface 926g extending from the lowermost exterior surface 928g to the uppermost exterior surface 910g. The concave portion 920g may include a sharp angle between two surfaces or (as shown between the lowermost exterior surface 928g and the inner transition surface 926g) may exhibit a transitional curved or planar surface therebetween. In an embodiment, each concave portion 920g may include a plurality of inner transition surfaces 926g. For example, the illustrated lowermost exterior surface 928g may exhibit a generally partial circular sector shape and the concave portion 920g may include a first inner transition surface extending from one edge of the lowermost exterior surface 928g and a second inner transition surface extending from another edge of the lowermost exterior surface 928g. The concave portion 920g may include a transition surface 992g extending between two adjacent inner transition surfaces 926g or the adjacent inner transition surfaces 926g may intersect at a relatively sharp corner. The concave portion 920g may exhibit a depth (not shown for clarity) measured from the uppermost exterior surface 920g to the lowermost exterior surface 928g and may be the same as the depth Da shown in FIG. 9B.

In an embodiment, the inner transitional surface 926g extends at an angle (not shown for clarity) relative to the lowermost exterior surface 928g. For example, the angle at which the inner transitional surface 926g extends relative to the lowermost exterior surface 928g may be about 15° to about 35°, about 30° to about 50°, about 45° to about 65°, about 60° to about 80°, or about 70° to about 90°. The angle may be selected based on the application of the PDC 900g, such as whether the PDC 900g is configured to be used to machine other material or for rock drilling.

In an embodiment, the PCD table 902g also includes an outer chamfer 912g that extends from the lateral surface 908g to a surface adjacent to the lateral surface 908g. For example, the outer chamfer 912g may extend from the lateral surface 908g to at least one of the uppermost exterior surface 910g, the lowermost exterior surface 928g, the inner transition surface 926g, a transitional planar or curved surface between two adjacent surfaces, or another surface.

In an embodiment, any of the surfaces illustrated in FIG. 9G may be machined using any of the laser machining methods disclosed herein. For example, at least one of the surfaces and/or concave portions illustrated in FIG. 9G may be difficult and/or impossible to machine using conventional machining techniques. In another embodiment, at least one of the surfaces illustrated in FIG. 9G (e.g., the lateral surface 908g) may be machined using conventional machining techniques.

FIG. 9H is top plan view of a PCD table 902h that is machined using any of the energy beams or energy pulses techniques disclosed herein, according to an embodiment. Except as otherwise disclosed herein, the PCD table 902h and its materials, elements, components, and methods of machining may be the same as or similar to the PCD table 902a, 902c, 902e, 902g (FIGS. 9A-9G) and their respective materials, components, element, or methods of machining. The PCD table 902h includes a working surface 910h and at least one lateral surface 908h. The PCD table 902h has been machined to remove a lateral portion 913h (shown using phantom lines) therefrom using any of the energy beam or energy pulses machining techniques disclosed herein. Removing the lateral portion 913h from the PCD table 902h forms an exposed lateral surface 994h. In the illustrated embodiment, the exposed lateral surface 994h is substantially planar. The exposed lateral surface 994h may be used as a spline.

FIG. 9I is a top plan view of a PCD table 902i that is machined using any of the energy beams or energy pulses machining techniques disclosed herein, according to an embodiment. Except as otherwise disclosed herein, the PCD table 902i and its materials, elements, components, and methods of machining may be the same as or similar to the PCD table 902a, 902c, 902e, 902g, 902h (FIGS. 9A-9H) and their respective materials, components, element, or methods of machining. The PCD table 902i includes a working surface 910i and at least one lateral surface 908i. The PCD table 902i has been machined to remove a lateral portion 913i (shown using phantom lines) therefrom using any of the energy beams or energy pulses machining techniques disclosed herein. Removing the lateral portion 913i from the PCD table 902i forms an exposed lateral surface 994i. In the illustrated embodiment, the exposed lateral surface 994i is concavely curved. The exposed lateral surface 994i may be used as a spline.

It is noted that different shapes of the lateral portion 913h, 913i of FIGS. 9H-9I may exhibit different shapes. For example, the lateral portion may exhibit a shape that forms a convexly curved exposed lateral surface. It is also noted that the PCD tables 902h, 902i of FIGS. 9H-9I may include a plurality of lateral portions removed therefrom. For example, a PCD table may include three lateral portions removed therefrom to form a generally triangular cross-sectional shape (in top view) or include four lateral portions removed therefrom to form a generally rectangular cross-sectional shape (in top view).

FIG. 9J is a top plan view of a PDC 900j that includes a PCD table 902j that is machined using any of the energy beams or energy pulses machining techniques disclosed herein, according to an embodiment. Except as otherwise disclosed herein, the PCD table 902j and its materials, elements, components, and methods of machining may be the same as or similar to the PCD table 902a, 902c, 902e, 902g, 902h, 902i (FIGS. 9A-9I) and their respective materials, components, element, or methods of machining. The PDC 900j includes a PCD table 902j bonded to a substrate 904j at an interfacial surface 906j thereof. The PCD table 902j also include a working surface 910j that is non-parallel to the interfacial surface 906j and non-perpendicular to at least one lateral surface 908j of the PCD table 902j. For example, the working surface 910j may extend at an angle β relative to the at least one lateral surface 908j. In particular, the angle β is measured from an imaginary extension of the lateral surface 908j and an imaginary line extending from a portion of the working surface 910j that is closest to the interfacial surface 906j and a center of the working surface 910j. In an embodiment, the angle β is less than 90°, such as about 30° to about 50°, about 45° to about 65°, about 60° to about 70°, about 65° to about 85°, or about 70° to less than 90°.

FIG. 9K is a side view of a PDC 900k that includes a PCD table 902k that is machined using any of the energy beams or energy pulses machining techniques disclosed herein, according to an embodiment. Except as otherwise disclosed herein, the PCD table 902k and its materials, elements, components, and methods of machining may be the same as or similar to the PCD table 902a, 902c, 902e, 902g, 902h, 902i, 902j (FIGS. 9A-9J) and their respective materials, components, element, or methods of machining. The PDC 900k includes a PCD table 902k bonded to a substrate 904k at an interfacial surface 906k thereof. The PCD table 902k also include a working surface 910k and a chamfer 912k that is machined using any of the energy beams or energy pulses machining techniques disclosed herein. For example, the chamfer 912k may extend at an angle δ relative to the working surface 910k. In an embodiment, the angle δ is less than 90°, such as greater than 0° to about 20°, about 15° to about 35°, about 30° to about 50°, about 45° to about 65°, about 60° to about 70°, about 65° to about 85°, or about 70° to less than 90°. The chamfer 212k may also extend into the substrate 904k. For example, the depth Dk that the chamfer 212k extends into the substrate 904k may be greater than about 20 μm, such as about 20 μm to about 100 μm, about 75 μm to about 250 μm, about 200 μm to about 500 μm, about 400 μm to about 750 μm, about 700 μm to about 1 mm, or greater than about 1 mm.

Referring to FIGS. 9A-9K, the PCD tables may be leached prior to forming the concave portions or after forming the concave portions. For example, if a PCD table is leached prior to forming the concave portions, the leached regions of the PCD table may extend a relatively uniform distance from the surface of the PCD table that is exposed to the leaching agent. As such, in one embodiment, the leaching profile of the leached region will substantially correspond to the shape of the surfaces that are exposed to the leaching agent. However, forming the concave portions after the PCD table is leached will cause variations in the thickness of the PCD table, especially the portion of the leached region that are proximate to the concave portions. For example, the concave portions may extend through only a portion of the leached region, extend completely through the leached region, or extend past the leached region into a non-leached region of the PCD table. In another example, if a PCD table is leached after forming the concave portions, the leached regions of the PCD table may extend relatively uniformly from the surface of the PCD table that is exposed to the leaching agent (i.e., to a certain distance from the exterior surface exposed to the leaching agent). For example, if the concave portion of the PCD table is exposed to the leaching agent, the leached region of the PCD table will exhibit a leached profile that generally corresponds to the concave portion.

In an embodiment, the energy beam machining techniques disclosed herein may be used to modify the cross-sectional shape of the PDCs disclosed herein. For example, the energy beam machining techniques disclosed herein may be used to remove PCD material from a lateral surface of the PCD table and/or a material (e.g., cemented carbide) from a lateral surface of a substrate bonded to the PCD table. For example, if the PDC exhibits a generally circular cross-section (e.g., the PDC is generally cylindrical), the energy beam machining techniques disclosed herein may be used to modify the cross-section of the PDC to be non-circular (e.g., generally elliptical, rectangular, square, or another suitable cross-section). The non-circular cross-section may inhibit or prevent rotation of the PDC within a recess (e.g., a recess defined by a bit body, a support ring, etc.) when a torque is applied to the PDC.

It is currently believed by the inventors that the energy beams or energy pulses machining techniques disclosed herein may form a profile of a surface of the PCD material that exhibits better tolerances than a profile of a surface of the PCD material formed using conventional machining techniques. As used herein, the profile of a surface of the PCD material includes the flatness, circularity, cylindricity, profile of a line, perpendicularity, parallelism, position, concentricity, symmetry, or combinations thereof of the PCD material. For example, the energy beams or energy pulses machining techniques disclosed herein may form a profile of a surface of the PCD material (e.g., any of the profiles of the surfaces of the PCD material shown in FIGS. 9A-9K) that exhibits a tolerance of about ±750 μm to about ±5 μm, such as about ±750 μm to about ±500 μm, about ±600 μm to about ±400 μm, about ±500 μm to about ±300 μm, about ±400 μm to about ±200 μm, about ±300 μm to about ±100 μm, about ±200 μm to about ±50 about ±75 μm to about ±25 μm, about ±50 μm to about ±30 μm, about ±40 μm to about ±20 μm, about ±30 μm to about ±10 μm, about ±25 μm to about ±5 μm, or about ±15 μm to about ±5 μm. It is also currently believed by the inventors that the energy beams or energy pulses machining techniques disclosed herein may form a profile of a surface of the PCD material (e.g., any of the profiles of the surfaces of the PCD material shown in FIGS. 9A-9K) that exhibits a toleration that is less than about ±5 μm, such as less than about ±4 μm, less than about ±3 μm, less than about ±2 μm, less than about ±1 μm, or less than about ±500 nm.

It is currently believed by the inventors that the energy beam or energy pulses machining techniques disclosed herein may form an angularity that exhibits better tolerances than an angularity formed using conventional machining techniques. For example, the energy beams or energy pulses machining techniques disclosed herein may form an angularity (e.g., any of the corners shown in FIGS. 9A-9K) that exhibits a tolerance of about ±0.003 radians to about radians ±0.09 radians, such as about ±0.05 radians to about ±0.09 radians, about ±0.025 radians to about ±0.075 radians, about ±0.01 radians to about ±0.05 radians, about ±0.009 radians to about ±0.02 radians, about ±0.005 radians to about ±0.01 radians, about ±0.0025 radians to about ±0.0075 radians, or about ±0.002 radians to about ±0.005 radians. It is also currently believed by the inventors that the energy beams or energy pulses machining techniques disclosed herein may form an angularity (e.g., any of the corners shown in FIGS. 9A-9K) that exhibits a toleration that is less than about ±0.002 radians, such as less than about ±0.0015 radians, less than about ±0.001 radians, less than about ±0.00075 radians, or less than about ±0.0005 radians.

### V. Applications for the PDCS and PCD Tables Disclosed Herein

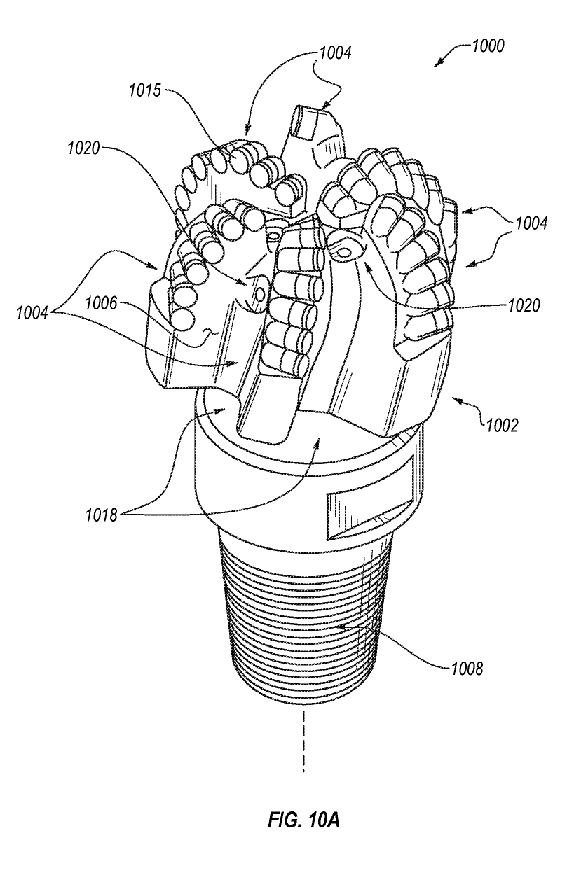

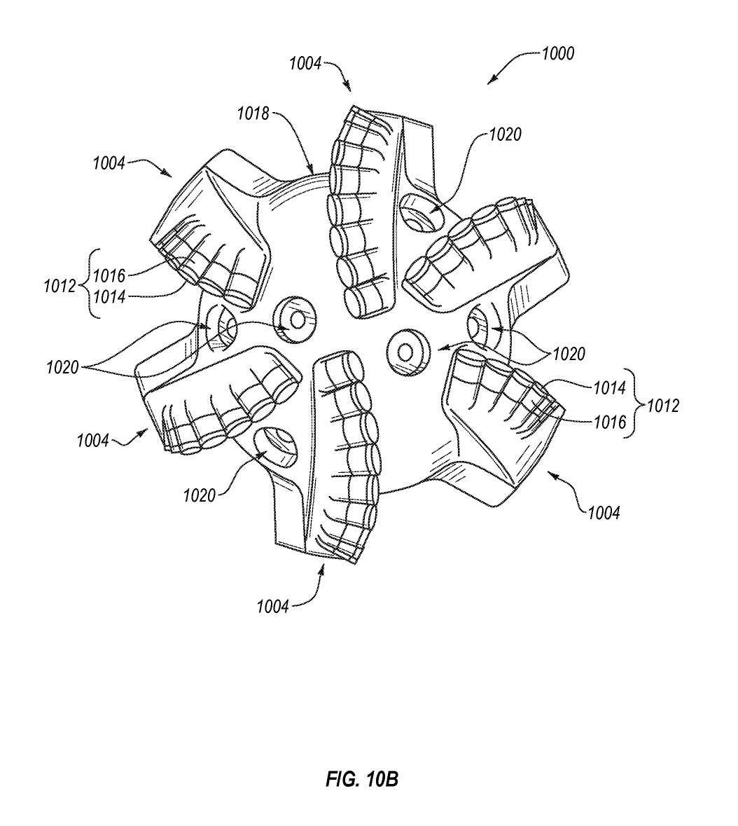

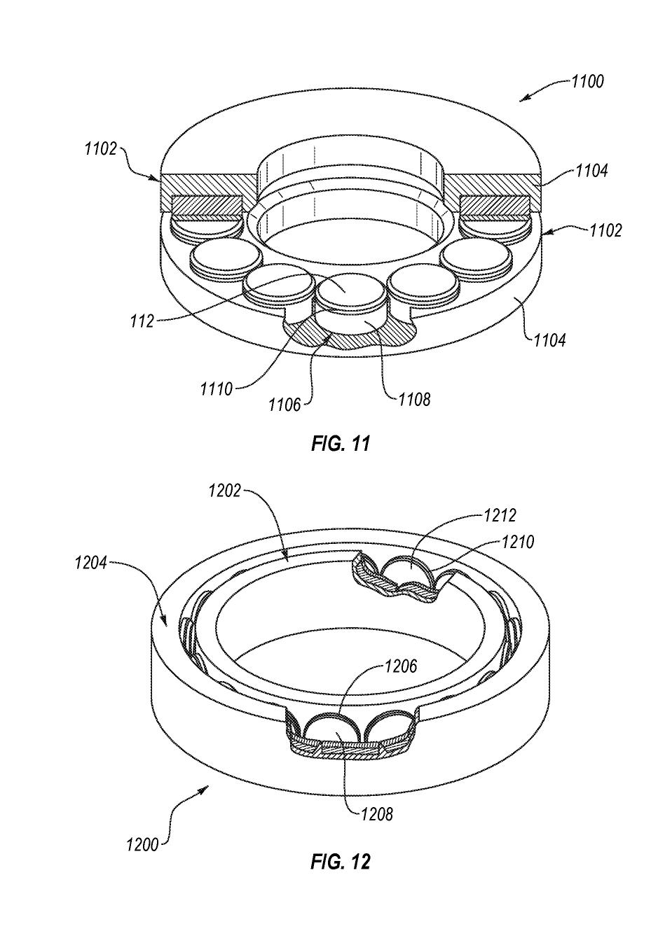

The disclosed PDC embodiments may be used in a number of different applications including, but not limited to, use in a rotary drill bit (FIGS. 10A and 10B), a thrust-bearing apparatus (FIG. 11), a radial bearing apparatus (FIG. 12), a mining rotary drill bit (e.g., a roof bolt drill bit), and a wire-drawing die. The various applications discussed above are merely some examples of applications in which the PDC embodiments may be used. Other applications are contemplated, such as employing the disclosed PDC embodiments in friction stir welding tools.

FIG. 10A is an isometric view and FIG. 10B is a top plan view of an embodiment of a rotary drill bit 1000 for use in subterranean drilling applications, such as oil and gas exploration. The rotary drill bit 1000 includes at least one PCD table and/or PDC configured according to any of the previously described PDC embodiments. The rotary drill bit 1000 comprises a bit body 1002 that includes radially and longitudinally extending blades 1004 with leading faces 1006, and a threaded pin connection 1008 for connecting the bit body 1002 to a drilling string. The bit body 1002 defines a leading end structure for drilling into a subterranean formation by rotation about a longitudinal axis and application of weight-on-bit. At least one PDC cutting element, configured according to any of the previously described PDC embodiments may be affixed to the bit body 1002. With reference to FIG. 10B, a plurality of PDCs 1012 are secured to the blades 1004. For example, each PDC 1012 may include a PCD table 1014 bonded to a substrate 1016. More generally, the PDCs 1012 may comprise any PDC disclosed herein that are machined using any of the energy beam machining techniques disclosed herein, without limitation. For examples, at least one exterior surface of the PCD table 1014 may exhibit any of the surface finishes disclosed herein and/or the PCD table 1014 may exhibit any of the shapes disclosed herein. In addition, if desired, in some embodiments, a number of the PDCs 1012 may be conventional in construction. Also, circumferentially adjacent blades 1004 define so-called junk slots 1018 therebetween, as known in the art. Additionally, the rotary drill bit 1000 may include a plurality of nozzle cavities 1020 for communicating drilling fluid from the interior of the rotary drill bit 1000 to the PDCs 1012.

FIG. 11 is an isometric cutaway view of an embodiment of a thrust-bearing apparatus 1100, which may utilize any of the disclosed PDC embodiments as bearing elements. The thrust-bearing apparatus 1100 includes respective thrust-bearing assemblies 1102. Each thrust-bearing assembly 1102 includes an annular support ring 1104 that may be fabricated from a material, such as carbon steel, stainless steel, or another suitable material. Each support ring 1104 includes a plurality of recesses (not labeled) that receives a corresponding bearing element 1106. Each bearing element 1106 may be attached to a corresponding support ring 1104 within a corresponding recess by brazing, press-fitting, using fasteners, or another suitable mounting technique. One or more, or all of bearing elements 1106 may be configured according to any of the disclosed PDC embodiments that are machined using the laser techniques disclosed herein, without limitation. For example, each bearing element 1106 may include a substrate 1108 and a PCD table 1110, with the PCD table 1110 including a bearing surface 1112 exhibiting any of the surface finishes and/or shapes disclosed herein. For example, the bearing surface 1112 may exhibit a rastering pattern that includes one or more microfeatures and at least a portion of the rastering pattern is parallel to the rotation of the bearing assemblies 1102.

In use, the bearing surfaces 1112 of one of the thrust-bearing assemblies 1102 bears against the opposing bearing surfaces 1112 of the other one of the thrust-bearing assemblies 1102. For example, one of the thrust-bearing assemblies 1102 may be operably coupled to a shaft to rotate therewith and may be termed a “rotor.” The other one of the thrust-bearing assemblies 1102 may be held stationary and may be termed a “stator.” The relatively fine surface finishes disclosed herein reduces the friction of the bearing surface 1112 compared to unpolished bearing surfaces which reduces the amount of heat generated during operation of the bearing apparatus 1100.

FIG. 12 is an isometric cutaway view of an embodiment of a radial bearing apparatus 1200, which may utilize any of the disclosed PDC embodiments as bearing elements. The radial bearing apparatus 1200 includes an inner race 1202 positioned generally within an outer race 1204. The outer race 1204 includes a plurality of bearing elements 1210 affixed thereto that have respective bearing surfaces 1212. The inner race 1202 also includes a plurality of bearing elements 1206 affixed thereto that have respective bearing surfaces 1208. One or more, or all of the bearing elements 1206 and 1210 may be configured according to any of the PDC embodiments disclosed herein that are machined using any of the laser techniques disclosed herein, without limitation. For example, one or more of the bearing surfaces 1208, 1212 may be machined using any of the laser machining methods disclosed herein to exhibit any of the surface finishes disclosed herein. For example, the bearing surfaces 1208,1212 may exhibit a rastering pattern that includes one or more microfeatures and at least a portion of the rastering pattern is parallel to the rotation of the inner and/or outer race 1202, 1204. The inner race 1202 is positioned generally within the outer race 1204 and, thus, the inner race 1202 and outer race 1204 may be configured so that the bearing surfaces 1208 and 1212 may at least partially contact one another and move relative to each other as the inner race 1202 and outer race 1204 rotate relative to each other during use.

The radial bearing apparatus 1200 may be employed in a variety of mechanical applications. For example, so-called “roller cone” rotary drill bits may benefit from the radial bearing apparatus disclosed 1200 herein. More specifically, the inner race 1202 may be mounted to a spindle of a roller cone and the outer race 1204 may be mounted to an inner bore formed within a cone and that such an outer race 1204 and inner race 1202 may be assembled to form a radial bearing apparatus.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

1. A method of machining a polycrystalline diamond (“PCD”) table, the method comprising:
providing the PCD table, the PCD table including a plurality of bonded diamond grains defining a plurality of interstitial regions, wherein at least one exterior surface of the PCD table exhibits a first surface roughness; and
directing a laser beam towards at least a portion of the at least one exterior surface effective to cause the at least a portion of at least one exterior surface to exhibit a second surface roughness that is less than the first surface roughness, wherein directing the laser beam includes:
directing at least one first laser pulse towards the at least one exterior surface to remove PCD from a first surface area; and
directing at least one second laser pulse towards the at least one exterior surface, wherein the at least one second laser pulse overlaps about 25% to about 99.95% of the first surface area.

2. The method of claim 1, wherein the first surface roughness is greater than about 3 μm Ra and the second surface roughness is less than about 3 μm Ra.

3. The method of claim 1 wherein providing the PCD table includes providing a polycrystalline diamond compact (“PDC”) including a cemented carbide substrate attached to the PCD table.

4. The method of claim 1 wherein:
the at least one exterior surface includes at least one concave portion; and
directing a laser beam towards at least a portion of the at least one exterior surface includes directing a plurality of laser pulses towards the at least one concave portion.

5. The method of claim 1 wherein:
directing at least one first laser pulse towards the at least one exterior surface to remove PCD from a first surface area includes forming a first recess extending in a first direction, the first recess exhibiting a first recess surface area; and
directing at least one second laser pulse towards the at least one exterior surface includes forming a second recess extending in a second direction that is substantially parallel to the first direction, wherein the second recess is at least offset relative to the first recess;
wherein the plurality of second laser pulses overlap 25% to 99.95% of the first recess surface area.

6. The method of claim 1 wherein:
directing at least one first laser pulse towards the at least one exterior surface includes forming a first recess extending in a first direction; and
directing at least one second laser pulse towards the at least one exterior surface includes forming a second recess extending in a second direction that is substantially parallel to the first direction;
wherein the second recess is at least offset relative to the first recess in two directions.

7. The method of claim 1, wherein:
directing at least one first laser pulse towards the at least one exterior surface includes forming a plurality of first recesses; wherein the plurality of first recesses are at least substantially parallel to each other; and
directing at least one second laser pulse towards the at least one exterior surface includes forming a plurality of second; wherein the plurality of second recesses are substantially parallel to each other;
wherein the plurality of second recesses are oriented at a nonparallel angle θ relative to plurality of first recesses.

8. The method of claim 7, wherein the nonparallel angle θ is:
a prime number; or
(90°−the prime number), (90°+the prime number), or (180°−the prime number).

9. The method of claim 7, wherein the nonparallel angle θ is about 30° to about 150°.

10. The method of claim 1, wherein directing a laser beam towards at least a portion of the at least one exterior surface includes directing a plurality of laser pulses exhibiting a generally top-hat energy distribution.

11. The method of claim 1, wherein directing a laser beam towards at least a portion of the at least one exterior surface includes directing a plurality of laser pulses exhibiting laser pulse duration of about 1 nanosecond to about 500 nanoseconds.

12. The method of claim 1, wherein directing a laser beam towards at least a portion of the at least one exterior surface includes directing a plurality of laser pulses exhibiting laser pulse duration of about 1 picosecond to about 1000 picoseconds.

13. The method of claim 1, wherein directing a laser beam towards at least a portion of the at least one exterior surface includes directing a plurality of laser pulses exhibiting laser pulse duration of about 1 femtosecond to about 1000 femtoseconds.

14. The method of claim 1, wherein directing a laser beam towards at least a portion of the at least one exterior surface includes removing a portion of the PCD table with substantially no detectable thermal damage.

15. The method of claim 1, further comprising subdividing the at least one exterior surface into a plurality of distinct regions, each of the plurality of distinct regions exhibiting a shape and size that allows an entirety thereof to be within an operable focal range and/or the operable angle range of the plurality of laser pulses.

16. A polycrystalline diamond compact (“PDC”), comprising:
a polycrystalline diamond (“PCD”) table including:
a plurality of bonded diamond grains defining a plurality of interstitial regions; and
at least one exterior surface, at least a portion of the at least one exterior surface exhibiting a surface roughness less than about 3 μm Ra, the at least a portion of the at least one exterior surface exhibiting a rastering pattern including one or more microfeatures.

17. The PDC of claim 16, further comprising a cemented carbide substrate bonded to the PCD table.

18. The PDC of claim 17, wherein:
the PCD table includes an interfacial surface adjacent to the cemented carbide substrate, the interfacial surface spaced from at least one exterior surface; and
the at least one exterior surface forms a working surface of the PCD table.

19. The PDC of claim 16, wherein the rastering pattern includes a plurality of grooves that are at least substantially parallel to each other and at least substantially evenly spaced, the plurality of grooves exhibiting an average depth less than about 6 μm.

20. The PDC of claim 16, wherein the PCD table includes:
an uppermost exterior surface;
an interfacial surface generally opposite the uppermost exterior surface;
at least one lateral surface extending between the uppermost exterior surface and the interfacial surface;
at least one lowermost exterior surface that is closer to the interfacial surface than the upper exterior surface; and
at least one inner transition surface extending between the uppermost exterior surface and the at least one lowermost exterior surface;
wherein the PCD table includes at least one concave portion that is at least partially surrounded by the uppermost exterior surface and at least partially defined by the at least one lowermost exterior surface and the at least one inner transition surface;
wherein at least one of the at least one lowermost exterior surface or the at least one inner transition surface exhibits a surface finish less than about 3 μm Ra.

21. The PDC of claim 16, wherein the portion of the at least one exterior surface exhibiting a surface roughness less than about 3 μm Ra exhibits substantially no detectable thermal damage.

22. The PDC of claim 16, wherein the PDC is mounted to a support ring of a bearing assembly, the at least one exterior surface forms a bearing surface of the bearing assembly

23. A drill bit comprising:
a bit body; and
at least one cutter coupled with the bit body, the at least one cutter including at least one polycrystalline diamond (“PCD”) table, the PCD table including:
a plurality of bonded diamond grains defining a plurality of interstitial regions; and
at least one exterior surface, at least a portion of the at least one exterior surface exhibiting a surface roughness less than about 3 μm Ra, the at least a portion of the at least one exterior surface exhibiting a rastering pattern including one or more microfeatures.
